(19) United States
(12) Patent Application Publication
(10) Pub. No.: US 2025/0180802 A1
(43) Pub. Date: Jun. 5, 2025

(54) MULTICORE OPTICAL FIBER WITH HETEROGENEOUS CORE ELEMENTS

(71) Applicant: CORNING INCORPORATED, CORNING, NY (US)

(72) Inventors: Douglas Llewellyn Butler, Painted Post, NY (US); Hazel Benton Matthews, III, Wilmington, NC (US); Snigdharaj Kumar Mishra, Wilmington, NC (US); Sonya Marie Raney, Wrightsville Beach, NC (US); Darren Andrew Stainer, Wilmington, NC (US); Pushkar Tandon, Painted Post, NY (US)

(21) Appl. No.: 18/956,862

(22) Filed: Nov. 22, 2024

Related U.S. Application Data
(60) Provisional application No. 63/605,125, filed on Dec. 1, 2023.

(51) Int. Cl. G02B 6/02

(52) U.S. Cl. CPC G02B 6/02042; G02B 6/02014

(57) ABSTRACT

A heterogeneous multicore optical fiber includes two or more core elements and features low counterpropagating crosstalk at large bend radius. At least a pair of the two or more core elements differ in propagation constant β and preferably have similar effective area A_{eff} at 1550 nm. The heterogeneous multicore optical fiber exhibits a critical bend radius corresponding to a maximum in counterpropagating crosstalk and marking a regime of higher bend radius over which counterpropagating crosstalk decreases. The critical bend radius is preferably less than 2000 mm.

This application claims the benefit of priority of U.S. Provisional Application Ser. No. 63/605,125 filed on Dec. 1, 2023, the content of which is relied upon and incorporated herein by reference in its entirety.

### FIELD OF THE DISCLOSURE

This disclosure pertains to optical fibers. More particularly, this disclosure relates to multicore optical fibers. Most particularly, this disclosure relates to multicore optical fibers having heterogeneous core elements.

### BACKGROUND OF THE DISCLOSURE

Optical fibers are utilized in a variety of telecommunication applications. The most widely used optical fibers include a single core element for transmission of optical signals. The core element of a single-core optical fiber includes a core region surrounded by one or more cladding regions. Since the transmission capacity of single-core optical fibers is currently approaching its theoretical limits, the demand for increased transmission capacity is currently being met through increases in the number of single-core optical fibers included in transmission cables. While a higher fiber count provides higher transmission capacity, it leads to larger cables and makes it difficult to retrofit existing space-constrained fiber installations with higher capacity cables. As a result, there is a need to develop solutions that provide higher transmission capacity without increasing the size of transmission cables.

One solution under consideration is multicore optical fibers. Multicore optical fibers include multiple core elements embedded in a common cladding. Each core element of a multicore optical fiber acts as an independent signal transmission channel. Since transmission capacity increases as the number of core elements in a multicore fiber increases, it is desirable to maximize the density of core elements in a given cross-sectional area of common cladding. Core element density can be increased by reducing the spacing between core elements. As the spacing between core elements is reduced, however, crosstalk between core elements occurs and signal quality degrades as signals transmitted in different core elements mix and interfere with each other. Core element density is also limited by the spacing between core elements and the outer surface of the common cladding. The common cladding is typically surrounded by one or more protective coatings and signal intensity in core elements proximate to the outer surface of the common cladding is decreased by tunneling through the common cladding into a protective coating when the core element is positioned too closely to the outer surface of the common cladding.

Multicore optical fibers are becoming increasingly important for space division multiplexing in submarine cable systems. Multicore optical fibers are important for increasing the cable capacity while still providing high signal transmission fidelity. For submarine systems, it is preferable for multicore optical fibers to include core elements having an effective area in the range from 100 μm² to 135 μm² at the common signal transmission wavelength of 1550 nm to minimize signal attenuation, reduce splice loss to standard single-core optical fibers, and mitigate tunnelling loss through tighter confinement of the optical signal in the core element.

The most common configuration of multicore optical fibers is the homogeneous design. In homogeneous multicore optical fibers, all core elements are identical. While it is possible to position the core elements of homogeneous multicore optical fibers in the common cladding in a way that reduces crosstalk in certain applications, crosstalk between core elements of homogeneous multicore optical fibers typically increases in cable deployments. The increase is due to the generally linear, weakly bent (large bend radius) configuration needed for deployment of submarine cables over extended distances. In local deployments, homogeneous multicore optical fibers are typically subjected to bending (small bend radius) to minimize space and facilitate compact installation. Bending of homogeneous multicore optical fibers reduces crosstalk between the core elements. Crosstalk increases in cable deployments as bending constraints are relaxed and the bending radius of the homogeneous multicore optical fibers increases.

In order to minimize crosstalk, the core elements of homogeneous multicore optical fibers are typically disposed symmetrically about the central longitudinal axis of the fiber. Symmetric arrangements tend to maximize the spacing between adjacent core elements, while also maintaining adequate separation of the core elements from the outer surface of the common cladding. Symmetric arrangements of homogeneous core elements, however, is problematic in installations where it is necessary to splice a homogeneous multicore optical fiber to integrate it with existing infrastructure because it becomes difficult to track individual core elements along the length of the fiber and to determine the correspondence of core elements at one end of the fiber with core elements at the other end of the fiber. In cable deployments, for example, the fibers extend through jackets over long distances and are subjected to twists and turns over the length of the cable. It is difficult to match core elements at one end of the cable with core elements at the other end of the cable. The enable identification of core elements, a marker element is typically included in the common cladding of homogeneous multicore optical fibers. A marker element is used as an alignment reference to enable determine the correspondence of core elements at opposite ends of the multicore optical fiber. The marker element is not used as a channel for transmitting an optical signal and is present solely for alignment purposes. The need for a marker element, however, complicates the manufacture of homogeneous multicore optical fibers.

There is accordingly a need for multicore optical fibers that exhibit low crosstalk in deployments, such as submarine cables, with large bend radius that allow for ready determination of the alignment of core elements, preferably without the need for inclusion of a marker element in the common cladding.

### SUMMARY

The present disclosure provides multicore optical fibers with low crosstalk between core elements in deployments with large bend radius. The multicore optical fibers are further configured, without marker elements, to permit determination of the relative alignment of opposite ends of the fibers so that correspondence between core elements at the opposite ends can be established. The multicore optical fibers include two or more heterogeneous core elements surrounded by a common cladding region

### The Present Description Extends to:

A heterogeneous multicore optical fiber comprising:
a plurality of core elements, each of the core elements having a core region doped with an alkali metal, the plurality including a first core element and a second core element, the first core element and the second core element differing in relative refractive index profile; and
a common cladding surrounding and directly contacting each of the core elements of the plurality;
   wherein
the core element spacing A between each pair of core elements is greater than or equal to 35 μm;
each of the core elements has an effective area A_{eff} at 1550 nm between 80 μm² and 150 μm², the effective areas A_{eff} at 1550 nm of the plurality of core elements spanning a range from a minimum effective area A_{eff,min} at 1550 nm to a maximum effective area A_{eff,max} at 1550 nm, the maximum effective area A_{eff,max} at 1550 nm and the minimum effective area A_{eff,min} at 1550 nm differing by less than 5 μm²;
each of the core elements has a cable cutoff wavelength λ_{CC} less than 1530 nm, the cable cutoff wavelengths λ_{CC} of the plurality of core elements spanning a range from a minimum cable cutoff wavelength λ_{CC,min} to a maximum cable cutoff wavelength λ_{CC,max}, the maximum cable cutoff wavelength λ_{CC,max} and the minimum cable cutoff wavelength λ_{CC,min} differing by less than 50 nm; and
the critical bend radius R_{crit} of the heterogeneous multicore optical fiber at 1550 nm is less than 1500 mm.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1A is a schematic depiction of a system used to determine crosstalk in a 1×2 multicore optical fiber.

FIG. 1B depicts a cross-section of a heterogeneous multicore glass fiber having two core elements arranged in a 1×2 configuration.

FIGS. 2A-2D show cross-sections of embodiments of core elements for heterogeneous multicore glass fibers having two or more core elements.

FIGS. 3A-3F show selected cross-sections of heterogeneous multicore optical fibers having two or more core elements of the types shown in FIGS. 2A-2D.

FIG. 4A shows a cross-section of a homogeneous multicore optical fiber with core elements arranged in a 2×2 configuration without a marker element.

FIG. 4B shows a cross-section of a homogeneous multicore optical fiber with core elements arranged in a 2×2 configuration with a marker element.

FIG. 4C shows a cross-section of a heterogeneous multicore optical fiber with core elements arranged in a 2×2 configuration without a marker element.

FIG. 5 depicts a relative refractive index profile of embodiments of core elements for a multicore optical fiber.

FIG. 6 shows counterpropagating crosstalk as a function of bend radius for a series of 1×2 multicore optical fibers.

FIG. 7 shows counterpropagating crosstalk as a function of bend radius for a series of 1×2 multicore optical fibers.

FIG. 8 depicts a relative refractive index profile of embodiments of core elements for a multicore optical fiber.

FIG. 9 shows counterpropagating crosstalk as a function of bend radius for a series of 1×2 multicore optical fibers.

FIG. 10 depicts a relative refractive index profile of embodiments of core elements for a multicore optical fiber.

FIG. 11 shows counterpropagating crosstalk as a function of bend radius for a series of 1×2 multicore optical fibers.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims that follow, reference will be made to a number of terms which shall be defined to have the following meanings:

“Include,” “includes,” “including”, or like terms means encompassing but not limited to, that is, inclusive and not exclusive.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is said to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges.

The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise. The term “plurality” means two or more.

Directional terms as used herein—for example up, down, right, left, front, back, top, bottom—are made only with reference to the figures as drawn and the coordinate axis provided therewith and are not intended to imply absolute orientation.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other but do touch an intervening material or series of intervening materials, where the intervening material or at least one of the series of intervening materials touches the other element. Contacting refers to placing two elements in direct or indirect contact. Elements in direct (indirect) contact may be said to directly (indirectly) contact each other.

As used herein, “directly adjacent” means directly contacting and “indirectly adjacent” mean indirectly contacting. The term “adjacent” encompasses elements that are directly or indirectly adjacent to each other.

“Optical fiber” refers to a waveguide having a glass portion surrounded by a coating. The glass portion is referred to herein as a “glass fiber”. The glass fiber of a single-core optical fiber consists of a single core region surrounded by one or more cladding regions, where the single core region and one or more cladding regions function collectively as a waveguide. The glass fiber of a multicore optical fiber includes two or more core elements surrounded by a common cladding, where each core element functions as a waveguide in the multicore optical fiber and each core element consists of a core region surrounded optionally by one or more dedicated cladding regions. A multicore optical fiber is referred to herein as “heterogeneous” if at least two of the two or more core elements of the multicore optical fiber differ in the value of the propagation constant β.

The “propagation constant” β of a core element corresponds to the change in phase of the guided mode in the core element per unit length of propagation of the guided mode in the core element. The “effective index” n_{eff} of a core element is the ratio of the propagation constant β of light with wavelength λ to the propagation constant β₀ of light with wavelength λ in vacuum:

$${n}_{eff} = \frac{β}{{β}_{0}}$$

$$where$$

$${β}_{0} = \frac{2 π}{λ}$$

For purposes of the present disclosure, the guided mode is the LP01 mode at a wavelength of 1550 nm, a wavelength at which the core elements described herein are single moded. For purposes of the present disclosure, the propagation constant β of a core element refers to the propagation constant of the core element in an isolated state in the common cladding region, free of coupling and crosstalk to other core elements.

“Radial position”, “radius”, or the radial coordinate “r” refers to radial position relative to the centerline (r=0) of a core element of the multicore optical fiber. Each of the two or more core elements of a multicore optical fiber has a centerline and a separate radial coordinate r. “Radial position”, “radius”, or the radial coordinate “R” refers to radial position relative to the centerline (R=0) of the multicore optical fiber. The multicore optical fiber has a single centerline and a single radial coordinate R. The radial coordinate r is used herein to refer to radial position in the core region and any of the dedicated cladding regions of the core elements described herein. The radial coordinate r or R will be used to refer to radial position in the common cladding described herein.

“Refractive index” refers to the refractive index at a wavelength of 1550 nm.

The “refractive index profile” is the relationship between refractive index or relative refractive index and radius. For relative refractive index profiles of core elements depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position r or R within a core region and/or any of the dedicated or common cladding regions. When relative refractive index varies with radial position r or R in a particular region of the fiber (e.g. core region and/or any of the dedicated or common cladding regions described herein), it is expressed in terms of its actual or approximate functional dependence, or in terms of its value at a particular radial position r or R within the region, or in terms of an average value applicable to the region as a whole. Unless otherwise specified, if the relative refractive index of a region (e.g. core region and/or any of the dedicated or common cladding regions) is expressed as a single value or as a parameter (e.g. Δ or Δ %) applicable to the region as a whole, it is understood that the relative refractive index in the region is constant, or approximately constant, and corresponds to the single value, or that the single value or parameter represents an average value of a non-constant relative refractive index dependence with radial position r or R in the region. For example, if i is a region of the glass fiber, the parameter Δᵢ refers to the average value of relative refractive index in the region, unless otherwise specified. Whether by design or a consequence of normal manufacturing variability, the dependence of relative refractive index on radial position may be sloped, curved, or otherwise non-constant.

“Relative refractive index,” as used herein, is defined in Eq. (1) as:

$$Δ ( r ) \% = 100 \frac{( {n}^{2} ( r ) - {n}_{ref}^{2} )}{2 {n}^{2} ( r )} \qquad ( 1 )$$

where n(r) is the refractive index at radial position r in the glass fiber, unless otherwise specified, and n_{ref} is the refractive index of pure silica glass, unless otherwise specified. For purposes of the present disclosure, n_{ref}=1.444, which is the refractive index of pure silica at 1550 nm. Accordingly, as used herein, the relative refractive index percent is relative to pure silica glass. As used herein, the relative refractive index is represented by Δ (or “delta”) or Δ % (or “delta %) and its values are given in units of “%”, unless otherwise specified. Relative refractive index may also be expressed as Δ(r) or Δ(r) %. An analogous definition of relative refractive index can be expressed in terms of radial coordinate R.

The average relative refractive index (Δₐᵥₑ) of a region of the fiber is determined from

$${Δ}_{a v e} = {\int }_{{r}_{i n n e r}}^{{r}_{o u t e r}} \frac{Δ ( r ) d r}{( {r}_{outer} - {r}_{i n n e r} )} \qquad ( 2 )$$

where rᵢₙₙₑᵣ is the inner radius of the region, rₒᵤₜₑᵣ is the outer radius of the region, and Δ(r) is the relative refractive index of the region. An analogous definition of average refractive index can be expressed in terms of radial coordinate R.

The term “α-profile” or “alpha profile” refers to a relative refractive index profile Δ(r) that has the functional form defined in Eq. (3):

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 3 )$$

where rₒ is the radial position at which Δ(r) is maximum, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and α is a real number referred to herein as a “profile parameter”. As the value of a increases, the relative refractive profile more closely approaches a step-index profile. For purposes of the present disclosure, relative refractive index profiles with values of α≥10 are regarded as step-index profiles and relative refractive index profiles with values of α<10 are regarded as graded-index profiles. Δ(r₀) for an α-profile may be referred to herein as Δₘₐₓ or, when referring to a specific region i of the fiber, as Δ_{i,max}. When the relative refractive index profile of the core region of a core element is described by an α-profile with r₀ occurring at the centerline (r=0) and r_{z} corresponding to the outer radius r₁ of the core region, Eq. (3) simplifies to Eq. (4):

$${Δ}_{1} ( r ) = {Δ}_{1 max} [ 1 - {[ \frac{r}{{r}_{1}} ]}^{α} ] \qquad ( 4 )$$

The “mode field diameter” or “MFD” of a core element of the multicore optical fiber is defined in Eq. (5) as:

$$M F D = 2 w$$

$${w}^{2} = 2 \frac{{\int }_{0}^{∞} {( f ( r ) )}^{2} rdr}{{\int }_{0}^{∞} {( \frac{df ( r )}{dr} )}^{2} rdr}$$

where f(r) is the transverse component of the electric field distribution of the guided optical signal in the core element and r is radial position relative to the centerline of the core element. “Mode field diameter” or “MFD” depends on the wavelength of the optical signal and is reported herein for a wavelength of 1310 nm or 1550 nm. Specific indication of the wavelength will be made when referring to mode field diameter. Unless otherwise specified, mode field diameter refers to the LP₀₁ mode at the specified wavelength. Each core element of a multicore optical fibers has a mode field diameter. The mode field diameter may be the same or different for different core elements.

“Effective area” of a core element of a multicore optical fiber is defined as:

$${A}_{eff} = \frac{2 {π [ {\int }_{0}^{∞} {( f ( r ) )}^{2} r d r ]}^{2}}{{\int }_{0}^{∞} {( f ( r ) )}^{4} r d r} \qquad ( 6 )$$

where f(r) is the transverse component of the electric field of the guided optical signal in the core element and r is radial position relative to the centerline of the core element. “Effective area” or “A_{eff}” depends on the wavelength of the optical signal and is understood herein to refer to a wavelength of 1310 nm or 1550 nm. Specific indication of the wavelength will be made when referring to effective area. Each core element of a multicore optical fibers has an effective area. The effective area may be the same or different for different core elements.

Reference to a difference between a first quantity and a second quantity means the result obtained by subtracting the second quantity from the first quantity. For example, a difference between a radius rᵢ and a radius rⱼ refers to rᵢ-rⱼ. Reference to a magnitude of a quantity or a magnitude of a difference refers to the absolute value of the quantity or the difference.

The cutoff wavelength of a core element of a multicore optical fiber is the minimum wavelength at which the core element will support (guide) only one propagating mode. For wavelengths below the cutoff wavelength, multimode transmission may occur and an additional source of dispersion may arise to limit the information carrying capacity of the core element of the multicore optical fiber. Cutoff wavelength will be reported herein as a “fiber cutoff wavelength” or a “cable cutoff wavelength”. The fiber cutoff wavelength is based on a 2-meter fiber length and the cable cutoff wavelength is based on a 22-meter cabled fiber length. The 22-meter cable cutoff wavelength is typically less than the 2-meter cutoff wavelength due to higher levels of bending and mechanical pressure in the cable environment. The fiber cutoff wavelength λ_{CF} is based on a 2-meter fiber length, while the cable cutoff wavelength λ_{CC} is based on a 22-meter cabled fiber length as specified in TIA-455-80: FOTP-80 IEC-60793-1-44 Optical Fibres—Part 1-44: Measurement Methods and Test Procedures—Cut-off Wavelength (21 May 2003), by Telecommunications Industry Association (TIA). Each core element of a multicore optical fibers exhibits a cutoff wavelength. The cutoff wavelength may be the same or different for different core elements of a multicore optical fiber.

“Chromatic dispersion”, herein referred to as “dispersion” unless otherwise noted, of a core element of a multicore optical fiber is the sum of the material dispersion and the waveguide dispersion. The zero-dispersion wavelength (λ₀) is the wavelength at which the dispersion has a value of zero. Dispersion slope is the rate of change of dispersion with respect to wavelength. Dispersion and dispersion slope are reported herein at a wavelength of 1550 nm and are expressed in units of ps/nm·km and ps/nm²·km, respectively. Each core element of a multicore optical fibers exhibits dispersion. The dispersion may be the same or different for different core elements.

The term “mode” refers to guided mode. The core elements of the multicore optical fibers described herein are single moded. A single-mode core element is designed to support only the fundamental LP01 mode over a substantial length of the optical fiber (e.g., at least several meters). (Under certain circumstances not relevant to the present disclosure, a single-mode core element can support multiple modes over short distances (e.g., tens of centimeters).) For purposes of the present disclosure, the birefringence of the core elements of the multicore optical fiber is assumed to be sufficiently low so that the two orthogonally polarized components of the LP01 mode are degenerate and propagate with the same phase velocity.

The term “coupling coefficient” κ, as used herein, is related to the overlap of the electric field of an optical signal in one core element with another core element. The coupling coefficient κ depends on the refractive index profile of the core elements, the distance between the core elements and the difference Δβ between the propagation constant β of the core elements. The square of the coupling coefficient, κ², is related to the average power in a core element as influenced by the power in other cores in the multicore optical fiber. The coupling coefficient κ is large when the spacing between core elements is small and decreases with increasing core element spacing. Core elements having a coupling coefficient κ of zero are said to be “uncoupled”. The coupling coefficient κ can be estimated from coupled power theory using the methods disclosed in M. Koshiba, K. Saitoh, K. Takenaga, and S. Matsuo, “Analytical Expression of Average Power-Coupling Coefficients for Estimating Intercore Crosstalk in Multicore Fibers,” IEEE Photonics J., 4(5), 1987-95 (2012); and T. Hayashi, T. Sasaki, E. Sasaoka, K. Saitoh, and M. Koshiba, “Physical Interpretation of Intercore Crosstalk in Multicore Fiber: Effects of Macrobend, Structure Fluctuation, and Microbend,” Optics Express, 21(5), 5401-12 (2013), the contents of which are incorporated by reference herein in their entirety.

The term “crosstalk” in a multicore optical fiber is a measure of the power of an optical signal that transfers from a reference core element to an adjacent core element. As used herein, the term “adjacent core element” refers to the core element that is nearest to the reference core element. The crosstalk from one core element to another core element depends on the coupling coefficient κ between the core elements. If an optical signal with power P₁ is launched into a reference core element, the co-propagating power P₄ coupled from the reference core element to an adjacent core element can be determined using the following equation:

$$\frac{{P}_{4}}{{P}_{1}} = \frac{2 {κ}_{12}^{2} L d}{1 + {( d Δ β )}^{2}}$$

where L is the length of the fiber, Δβ is the difference in propagation constants between the two adjacent core elements, κ₁₂ is the coupling coefficient, and d is the correlation length. The crosstalk X (in dB) is then determined using the following equation:

$$X = 10 log ( \frac{{P}_{4}}{{P}_{1}} ) .$$

The crosstalk between the two adjacent core elements increases linearly with fiber length in the linear scale but does not increase linearly with fiber length in the dB scale. As used herein, crosstalk is referenced to a 100 km length L of optical fiber. However, crosstalk can also be represented with respect to alternative optical fiber lengths, with appropriate scaling. For optical fiber lengths other than 100 km, the crosstalk between adjacent core elements can be determined using the following equation:

$$X ( L ) = X ( 100 ) + 10 log ( \frac{L}{100} )$$

For example, for a 10 km length of optical fiber, the crosstalk can be determined by adding “−10 dB” to the crosstalk value for a 100 km length optical fiber. For a 1 km length of optical fiber, the crosstalk can be determined by adding “−20 dB” to the crosstalk value for a 100 km length of optical fiber. For transmission of optical signals over long distances in a multicore fiber, the crosstalk per 100 km length should be less than or equal to −30 dB, less than or equal to −40 dB, or even less than or equal to −50 dB.

Crosstalk leads to transfer of an optical signal from a reference core element to an adjacent core element. Once crosstalk occurs, the transferred signal can propagate in both directions in the adjacent core element. A distinction is made herein between co-propagating crosstalk and counterpropagating crosstalk. Co-propagating crosstalk refers to the power of the crosstalk signal transferred to the adjacent core element as measured at the end of the adjacent core element corresponding to the end of the reference core element into which the signal with power P₁ was launched. Counterpropagating crosstalk refers to the power of the crosstalk signal transferred to the adjacent core element as measured at the end of the adjacent core element opposite to the end of the reference core element into which the signal with power P₁ was launched. Typically, the power of counterpropagating crosstalk is less than the power of co-propagating crosstalk.

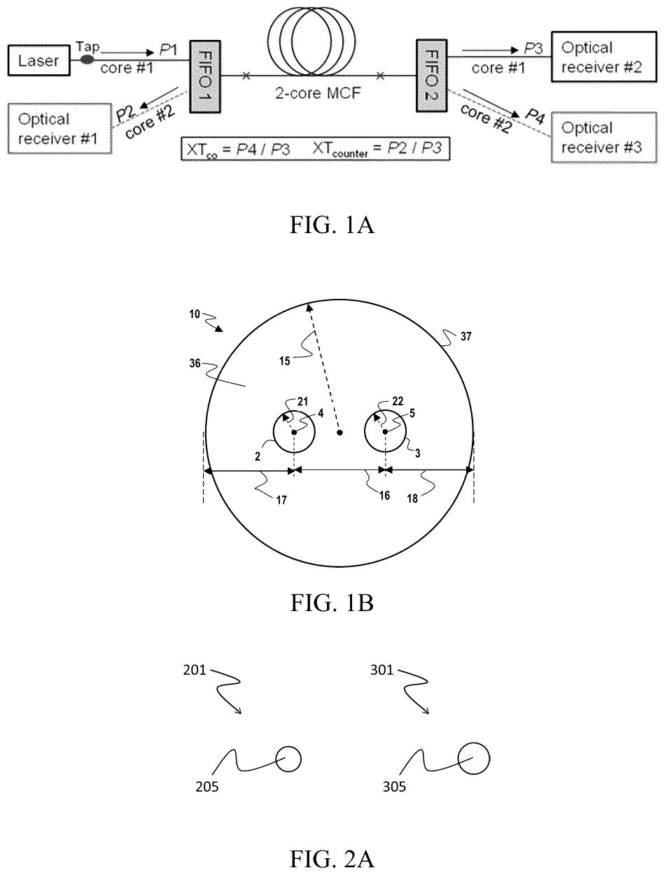

A system to measure crosstalk in a 1×2 multicore optical fiber is shown schematically in FIG. 1A. To measure the crosstalk, multicore fibers with a length between 20 km and 25 km can be tested over a range of bend radius with the system. As shown in FIG. 1A, the system comprises a tunable laser source with a wavelength of 1550 nm and a linewidth of 200 kHz, a tap to monitor the laser output power, and a 1×2 multicore optical fiber fan-in/fan-out device (FIFO 1) spliced to one end of the fiber to inject light with power P₁ from the laser source into one end of one core element of the fiber. Fan-in/fan-out device (FIFO 1) is further coupled to optical receiver #1 to enable detection of the power P₂ of backward-propagating light at one end of the other core element. A second fan-in/fan-out device (FIFO 2) is spliced at the other ends of the core elements of the multicore optical fiber and its outputs are connected to optical receivers #2 and #3 to measure the power of forward-propagating light P₃ and P₄ out of each core element at the end opposite the end in which the source light with power P₁ is injected. Co-propagating crosstalk (XT_{co}) is defined as the power ratio P₄/P₃ and counterpropagating crosstalk (XT_{counter}) is defined as the power ratio P₂/P₃. The optical receivers #1, #2, and #3 are each a high sensitivity detector with −109 dBm noise sensitivity and linearity error with <20% deviation over the entire range of measured power (+5 to −75 dBm). All three optical receivers are calibrated. The multicore optical fiber used to fabricate the two fan-in/fan-out devices (FIFO 1, FIFO 2) has the same mode field diameter and core element spacing as the tested multicore optical fiber.

Techniques for determining co-propagating and counterpropagating cross talk between cores in a multicore optical fiber can be found in Akihide Sano et al., “Crosstalk-Managed High Capacity Long Haul Multicore Fiber Transmission With Propagation-Direction Interleaving,” Journal of Lightwave Technology, Vol. 32, No. 16, p. 2771-2779, published Aug. 15, 2014, and T. Hayashi, T. Nagashima, A. Inoue, H. Sakuma, T. Suganuma and T. Hasegawa, “Uncoupled Multi-Core Fiber Design for Practical Bidirectional Optical Communications”, Paper #MIE.1, Optical Fiber Communications Conference 2022, Optica Publishing Group (2022).

Crosstalk is reported herein in units of “dB/100 km”, which means decibels per 100 km of fiber length.

The multicore optical fibers disclosed herein include two or more core elements. Each core element includes a core region and optionally includes one or more dedicated cladding regions. The multicore optical fiber also includes a cladding region common to at least two of the two or more core elements. The core regions and cladding regions are glass. The dedicated and common cladding regions may include multiple regions that differ in relative refractive index. Types of cladding regions include dedicated cladding regions and common cladding regions. A cladding region is said to be “dedicated” if it surrounds the core region of only one core element of the two or more core elements and is said to be “common” if it surrounds the core regions of at least two core elements of the two or more core elements. In embodiments described herein, the common cladding region surrounds two or more core elements of the multicore fiber. Preferably, the at common cladding region is common to all core elements of the multicore optical fiber. Each core element of the multicore optical fiber includes at least one dedicated cladding region and is surrounded by at least one common cladding region. In a preferred embodiment, each core element includes at least one dedicated cladding region directly adjacent to the core region of the core element. In embodiments in which each core element includes two or more dedicated cladding regions, at least one of the two or more dedicated cladding regions is directly adjacent to the core region and each of the others of the two or more dedicated cladding regions is directly adjacent to another of the two or more dedicated cladding region. In another preferred embodiment, the common cladding region is directly adjacent to the dedicated cladding region furthest removed from the core region of each of the core elements. A common cladding region defines the outer surface of the glass fiber. In some embodiments, an outer common cladding region surrounds and is directly adjacent to a common cladding region.

In other embodiments, one or more intermediate common cladding regions is disposed between the inner common cladding region and the outer common cladding region. The multicore optical fibers preferably further include a coating surrounding a common cladding region.

In some embodiments, the core region of a core element includes a dedicated inner cladding region surrounding and directly adjacent to the core region and a common cladding region surrounding and directly adjacent to the dedicated inner cladding region. The relative refractive index of the dedicated inner cladding region is less than the relative refractive index of the core region. In some embodiments, the relative refractive index of the common cladding region is greater than the relative refractive index of the dedicated inner cladding region.

In some embodiments, the core region of a core element includes a dedicated inner cladding region surrounding and directly adjacent to the core region, a dedicated depressed index cladding region surrounding and directly adjacent to the dedicated inner cladding region, and a common cladding region surrounding and directly adjacent to the dedicated depressed index cladding region. The relative refractive index of the dedicated inner cladding region is less than the relative refractive index of the core region and the relative refractive index of the dedicated depressed index cladding region is less than the relative refractive index of the dedicated inner cladding region. In some embodiments, the relative refractive index of the common cladding region is less than the relative refractive index of the dedicated inner cladding region. In some embodiments, the relative refractive index of the common cladding region is greater than the relative refractive index of the dedicated depressed index cladding region.

In some embodiments, the core region of a cladding element includes a dedicated outer cladding region disposed between a dedicated inner cladding region and a common cladding region or between a dedicated depressed index cladding region and a common cladding region.

Preferably, when present, a dedicated outer cladding region is surrounded by and directly adjacent to the common cladding region and the dedicated outer cladding region surrounds and is directly adjacent to a dedicated inner cladding region or a dedicated depressed index cladding region.

The core region, inner cladding region, depressed index cladding region, outer cladding region, and common cladding region are also referred to herein as core, cladding, inner cladding, depressed index cladding, outer cladding, and common cladding, respectively.

Whenever used herein, radial position r₁ and relative refractive index Δ₁ or Δᵢ(r) refer to a core region, radial position r₂ and relative refractive index Δ₂ or Δ₂(r) refer to a dedicated inner cladding region, radial position r₃ and relative refractive index Δ₃ or Δ₃(r) refer to a dedicated depressed index cladding region, radial position r₄ and relative refractive index Δ_{4doc} or Δ_{4doc}(r) refer to a dedicated outer cladding region, radial position R₄ and relative refractive index Δ₄ or Δ₄(R) refer to a common cladding region, radial position R₅ refers to a primary coating, and radial position R₆ refers to a secondary coating. Each radial position rᵢ (i=1, 2, 3, or 4) and Rᵢ (i=4, 5, or 6) refers to the outer radius of the region associated with the value i. For example, r₁ refers to the outer radius of a core region, r₂ refers to the outer radius of a dedicated inner cladding region etc.

When helpful for purposes of clarity to identify radial positions and relative refractive indices of different core regions, different dedicated inner cladding regions, different dedicated depressed index cladding regions, and/or different dedicated outer cladding regions of the core elements of a multicore glass fiber, a second identifying subscript will be used. For example, the radius rᵢⱼ refers to the radial position rᵢ of the j^{th} region of type i in the multicore glass fiber and Δ_{i,j} refers to the relative refractive index Δᵢ of the j^{th} region of type i in the multicore glass fiber. Regions of type i include a core region (i=1), a dedicated inner cladding region (i=2), a dedicated depressed index cladding region (i=3) and a dedicated outer cladding region (i=4). For purposes of illustration, the radial positions r_{1,1} and r_{1,2} refer to the outer radius rᵢ (i=1) of a core region of a first core element (j=1) and the outer radius rᵢ (i=1) of a core region of a second core element (j=2) of a multicore glass fiber, respectively. Similarly, the relative refractive indices Δ_{1,1} and Δ_{1,2} refer to the relative refractive index Δ₁ (i=1) of a core region of a first core element (j=1) and the relative refractive index Δ₁ (i=1) of a core region of a second core element (j=2) of a multicore glass fiber, respectively. When a symbol designating a radial position or relative refractive index includes a single subscript, it is understood that the symbol and subscript refer to any of the regions of type i in any of the core elements of the multicore glass fiber, where it is further understood that the numerical value associated with the symbol and subscript may be the same or different for the different regions of type i in the different core elements of the multicore glass fiber. For example, the radial position r₁ refers to the outer radius of the core region of any of the core elements of the multicore glass fiber, where it is understood that the numerical value of the outer radius r₁ may be the same or different for any two of the core regions in the different core elements of the multicore glass fiber.

The relative refractive index Δ₁(r) has a maximum value Δ₁ₘₐₓ and a minimum value Δ₁ₘᵢₙ. The relative refractive index Δ₂(r) has a maximum value Δ₂ₘₐₓ and a minimum value Δ₂ₘᵢₙ. The relative refractive index Δ₃(r) has a maximum value Δ₃ₘₐₓ and a minimum value Δ₃ₘᵢₙ. The relative refractive index Δ_{4doc}(r) has a maximum value Δ_{4docmax} and a minimum value Δ_{4docmin}. The relative refractive index Δ₄(R) has a maximum value Δ₄ₘₐₓ and a minimum value Δ₄ₘᵢₙ. The relative refractive index Δ₅(R) has a maximum value Δ₅ₘₐₓ and a minimum value Δ₅ₘᵢₙ. In embodiments in which the relative refractive index is constant or approximately constant over a region (e.g., a step-index profile), the maximum and minimum values of the relative refractive index are equal or approximately equal. Unless otherwise specified, if a single value is reported for the relative refractive index of a region (dedicated or common), the single value corresponds to an average value for the region. For core regions with an α-profile or graded-index relative refractive index profile, Δ₁ₘₐₓ corresponds to the value of Δ₁ at the centerline (r=0) of the core region in some embodiments. In some embodiments, Δ₁ₘₐₓ is offset from the centerline (r=0) of the core (e.g., a centerline dip in relative refractive index may be present).

It is understood that a core region is substantially cylindrical in shape and that a dedicated inner cladding region, a dedicated depressed index cladding region, a dedicated outer cladding region, a primary coating, and a secondary coating are substantially annular in shape.

Common cladding regions have shapes with internal cavities sized to accommodate the two or more core elements. The outer surface of a common cladding region preferably has a circular circumference that defines the radius R₄. Annular regions are characterized in terms of an inner radius and an outer radius. Radial positions r₁, r₂, r₃, and r₄, refer herein to the outermost radii of a core region, a dedicated inner cladding region, a dedicated depressed index cladding region, and a dedicated outer cladding, respectively, of a core element. The glass fiber of the multicore optical fiber is preferably substantially cylindrical in shape and R₄ refers to the outer radius of the glass fiber, which corresponds to the outer radius of the common cladding. In some embodiments, the glass fiber is surrounded by a primary coating and a secondary coating, each of which is substantially annular in shape. The radius R₅ refers to the outer radius of the primary coating and the radius R₆ refers to the outer radius of the secondary coating.

When two dedicated cladding regions are directly adjacent to each other, the outer radius of the inner of the two dedicated cladding regions coincides with the inner radius of the outer of the two dedicated cladding regions. In one embodiment, for example, the glass fiber includes a core element having a core region with a dedicated inner cladding region surrounded by and directly adjacent to a dedicated depressed index cladding region. In such an embodiment, the radius r₂ corresponds to the outer radius of the dedicated inner cladding region and the inner radius of the dedicated depressed index cladding region. In embodiments in which the relative refractive index profile includes a dedicated inner cladding region directly adjacent to the core region, the radial position r₁ corresponds to the outer radius of the core region and the inner radius of the dedicated inner cladding region.

The following terminology applies to embodiments in which the relative refractive index profile of a core element includes a dedicated inner cladding region surrounding and directly adjacent to a core region. The difference r₂−r₁ between radial position r₂ and radial position r₁ is referred to herein as the thickness of the dedicated inner cladding region.

The following terminology applies to embodiments in which the relative refractive index profile of a core element includes a dedicated inner cladding region surrounding and directly adjacent to a core region, a dedicated depressed index cladding region surrounding and directly adjacent to the dedicated inner cladding region. The difference r₂−r₁ between radial position r₂ and radial position r₁ is referred to herein as the thickness of the dedicated inner cladding region. The difference r₃−r₂ between radial position r₃ and radial position r₂ is referred to herein as the thickness of the dedicated depressed index cladding region.

In embodiments with a primary coating surrounding and directly adjacent to a common cladding region, and a secondary coating surrounding and directly adjacent the primary coating, the difference R₅−R₄ between radial position R₅ and radial position R₄ is referred to herein as the thickness of the primary coating and the difference R₆−R₅ between radial position R₆ and radial position R₅ is referred to herein as the thickness of the secondary coating.

As will be described further hereinbelow, the relative refractive indices of the core region, dedicated inner cladding region, dedicated depressed index cladding region, dedicated outer cladding region, and common cladding region may differ. The relative refractive index of the core region is higher than the relative refractive index of any of the dedicated or common cladding regions. The relative refractive index of an inner cladding region may be greater than, less than or equal to the relative refractive index of a common cladding region. In embodiments in which a core element includes a core region, a dedicated inner cladding region, a dedicated depressed index cladding region, a common interior cladding region and a common exterior cladding region, the relative refractive index of the dedicated depressed index cladding region is less than the relative refractive index of the dedicated inner cladding region and the relative refractive index of the common cladding region. Any or all of the relative refractive indices, radial positions, and thicknesses of the core region, dedicated inner cladding region, dedicated depressed index cladding region, and dedicated outer cladding region for different core elements of the multicore optical fiber may be the same or different. In different embodiments, all core elements of the multicore optical fiber have step-index profiles, all core elements of the multicore optical fiber have graded-index profiles, or some core elements of the multicore optical fiber have step-index profiles and other core elements of the multicore optical fiber have graded-index profiles.

Each of the regions may be formed from doped or undoped silica glass. Variations in refractive index relative to undoped silica glass are accomplished by incorporating updopants or downdopants at levels designed to provide a targeted refractive index or refractive index profile using techniques known to those of skill in the art. Updopants are dopants that increase the refractive index of the glass relative to the undoped glass composition. Downdopants are dopants that decrease the refractive index of the glass relative to the undoped glass composition. In one embodiment, the undoped glass is silica glass. When the undoped glass is silica glass, updopants include Cl, Br, Ge, Al, P, Ti, Zr, Nb, and Ta, and downdopants include F and B. Other dopants, such as alkali metals (e.g., Na, K), that have little effect on the refractive index of silica glass may also be included. Regions of constant refractive index may be formed by not doping or by doping at a uniform concentration over the thickness of the region. Regions of variable refractive index are formed through non-uniform spatial distributions of dopants over the thickness of a region and/or through incorporation of different dopants in different regions.

The present disclosure provides multicore glass fibers and multicore optical fibers as well as ribbons and cables containing multicore glass fibers and multicore optical fibers. In a ribbon, the multicore glass fibers or multicore optical fibers are aligned relative to one another in a substantially planar and parallel relationship. The multicore glass fibers or multicore optical fibers in ribbons are encapsulated by a ribbon matrix in any of several known configurations (e.g., edge-bonded ribbon, thin-encapsulated ribbon, thick-encapsulated ribbon, or multi-layer ribbon) by conventional methods of making fiber optic ribbons. The ribbon contains two or more multicore glass fibers or multicore optical fibers. In some embodiments, the ribbon contains four or more, or eight or more, or twelve or more, or sixteen or more multicore glass fibers or multicore optical fibers. The ribbon matrix has tensile properties similar to the tensile properties of a secondary coating and is formed from the same, similar, or different composition used to prepare a secondary coating. A cable includes a plurality of multicore glass fibers or multicore optical fibers surrounded by a jacket. The jacket typically has a circular cross-section and is flexible or rigid depending on the application requirement. Multicore glass fibers or multicore optical fibers are densely or loosely packed into a conduit enclosed by an inner surface of the jacket. The number of fibers placed in the jacket is referred to as the “fiber count” of cable. The jacket is formed from an extruded polymer material and may include multiple concentric layers of polymers or other materials. The cable may also include one or more strengthening members embedded within the jacket or placed within the conduit defined by the inner surface of the jacket. Strengthening members include fibers or rods that are more rigid than the jacket. The strengthening member is made from metal, braided steel, glass-reinforced plastic, fiber glass, or other suitable material. The cable may include other layers surrounded by the jacket (e.g., armor layers, moisture barrier layers, rip cords, etc.). The cable may have a stranded, loose tube core or other fiber optic cable construction.

For purposes of illustration, much of the disclosure that follows describes multicore glass fibers having two core elements. It should be apparent, however, that multicore glass fibers having more than two core elements are similarly contemplated and within the scope of the disclosure. The number of core elements in the multicore fiber is two or more, or three or more, or four or more, or six or more, or eight or more, or twelve or more, or sixteen or more, or between 2 and 32, or between 3 and 28, or between 4 and 24, or between 6 and 20, or between 8 and 16. Particular characteristics of the arrangement of core elements that minimize crosstalk between core elements or tunneling outside of the glass fiber are also described. These characteristics apply similarly to any pair or combination of core elements in multicore glass fibers having more than two core elements. Although the disclosure emphasizes multicore glass fibers, it is further understood that one or more polymer coatings may be applied to the outer surface of the multicore glass fiber. Polymer coatings include primary coatings, secondary coatings, ink layers, and matrix materials known in the art.

One example of a relative refractive index profile of a core element is a step-index relative refractive index profile, which has a core region whose refractive index is constant or approximately constant with distance from the centerline of the core element. One example of a step-index core element is a core element with a core region having a relative refractive index profile with an α-profile with a value of a greater than or equal to 10. Another example of a relative refractive index profile of a core element is a graded-index profile, which has a core region whose refractive index varies with distance from the centerline of the core element. One example of a graded-index core element is a core element with a core region having a relative refractive index profile with an α-profile with a value of a less than 10.

FIG. 1B illustrates a heterogeneous multicore glass fiber with two cores in cross-sectional view. Heterogeneous multicore glass fiber 10 is a 1×2 multicore optical fiber that includes core element 2 and core element 3, which are surrounded by common cladding 36. Core element 2 has a center 4 positioned on a centerline passing through core element 2 and an outer radius 21 (corresponding in various embodiments described below to r₁, r₂, r₃, or r₄). Core element 3 has a center 5 positioned on a centerline passing through core element 3 and an outer radius 22 (corresponding in various embodiments described below to r₁, r₂, r₃, or r₄). The core element spacing between the centerlines of core elements 2 and 3 is depicted at 16. As used herein, “core element spacing” of a core element refers to the distance between the centerline of the core element and the centerline of the closest core element. A core element and its closest core element are said to be “adjacent” to each other and are referred to herein as “adjacent core elements” or as a pair of adjacent core elements. The core element spacings for the different core elements in a multicore optical fiber having more than two core elements may be the same or different. The edge spacing between the centerline of core element 2 and the outer surface 37 of common cladding region 36 is depicted at 17. The edge spacing between the centerline of core element 3 and the outer surface 37 of common cladding region 36 is depicted at 18. As used herein, “edge spacing” of a core element refers to the shortest distance between the centerline of the core element and the outer surface 37 of the common cladding region 36 (the surface defined by the radius R₄ (shown at 15)). Edge spacings 17 and 18 may be the same or different. In embodiments with three or more core elements, the edge spacing of different core elements may be the same or different.

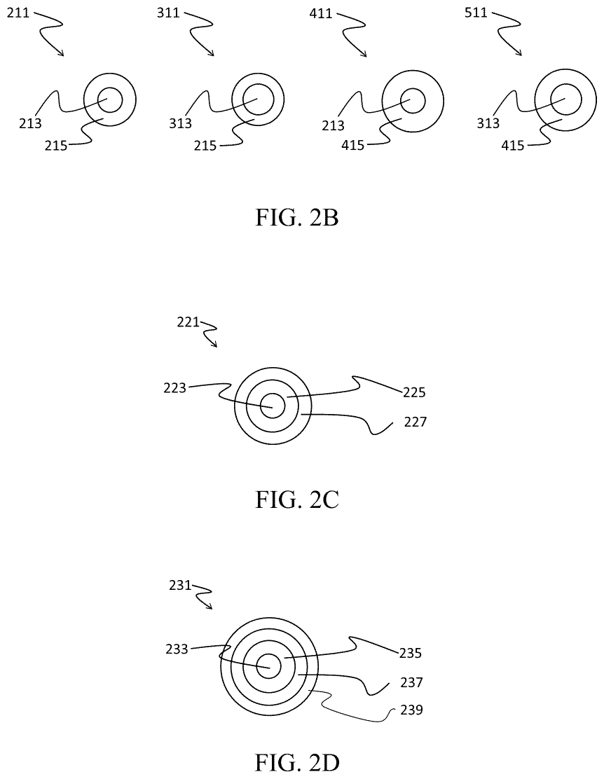

In heterogeneous multicore optical fiber 10, the propagation constant β for core element 2 differs from the propagation constant β for core element 3. Differences in the propagation constant β result from differences in the refractive index, dimensions and/or configuration of core element 2 and 3. FIGS. 2A-2D shows various examples of core elements in accordance with the present disclosure. FIG. 2A shows core element 201 with core region 205. Core element 201 lacks a dedicated cladding region and is surrounded by and in direct contact with common cladding 36 in a multicore optical fiber. Core element 301 is a variant of core element 201 that includes core region 305 with a larger radius than core region 205. Core regions 205 and 305 may have the same or different relative refractive index and each has a relative refractive index greater than the relative refractive index of common cladding 36.

FIG. 2B shows core element 211 with a core region 213 and a dedicated cladding region 215. Core region 213 has a higher relative refractive index than dedicated cladding region 215. Core element 311 is a variant of core element 211 that includes dedicated cladding region 215 and core region 313 with a larger radius than core region 213. Core element 411 is a variant of core element 211 that includes core region 313 and a dedicated cladding region 415 and with a larger radius than dedicated cladding region 215. Core element 511 is a variant of core element 211 that includes dedicated core region 313 with a larger radius than core region 213 and dedicated cladding region 415 and with a larger radius than dedicated cladding region 215. In embodiments, dedicated cladding regions 215 and 415 are a dedicated inner cladding region, a dedicated depressed index cladding region, or dedicated outer cladding region as described herein. Core regions 213 and 313 may have the same or different relative refractive index and each has a relative refractive index greater than the relative refractive index of common cladding 36. Dedicated cladding regions 215 and 415 may have the same or different relative refractive index and each has a relative refractive index greater than, equal to, or less than the relative refractive index of common cladding 36.

FIG. 2C shows core element 221 with core region 223, first dedicated cladding region 225, and second dedicated cladding region 227. Core region 223 has a higher relative refractive index than either first dedicated cladding region 225 or second dedicated cladding region 227. Core region 223 also has a relative refractive index greater than the relative refractive index of common cladding 36. First dedicated cladding region 225 and second dedicated cladding region 227 differ in relative refractive index and each has a relative refractive index greater than, equal to, or less than the relative refractive index of common cladding 36. Embodiments (not shown) further include variations of core element 221 in which one or more of the core region, first dedicated cladding region and second dedicated cladding region differ in radius and/or relative refractive index from core region 223, first dedicated cladding region 225, and second dedicated cladding region 227.

FIG. 2D shows core element 231 with core region 233, first dedicated cladding region 235, second dedicated cladding region 237, and third dedicated cladding region 239. Core region 223 has a higher relative refractive index than any of first dedicated cladding region 235, second dedicated cladding region 237, and third dedicated cladding region 239. Core region 233 also has a relative refractive index greater than the relative refractive index of common cladding 36. First dedicated cladding region 235, second dedicated cladding region 237, and third dedicated cladding region 239 differ in relative refractive index and each has a relative refractive index greater than, equal to, or less than the relative refractive index of common cladding 36. Second dedicated cladding region 237 is preferably a dedicated depressed index cladding region having a lower relative refractive index than first dedicated cladding region 235, third dedicated cladding region 239, and common cladding 36. Embodiments (not shown) further include variations of core element 231 in which one or more of the core region, first dedicated cladding region, second dedicated cladding region, and third dedicated cladding region differ in radius and/or relative refractive index from core region 233, first dedicated cladding region 235, second dedicated cladding region 237, and third dedicated cladding region 239.

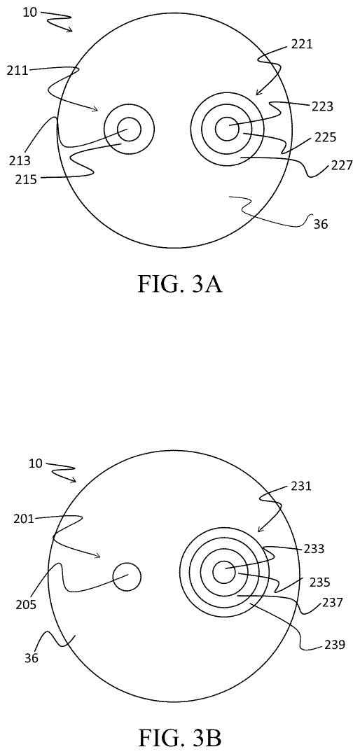

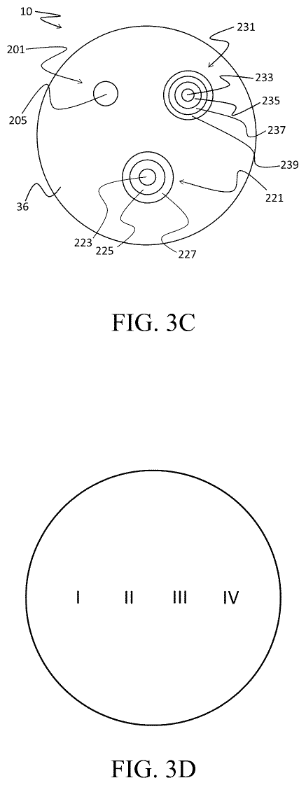

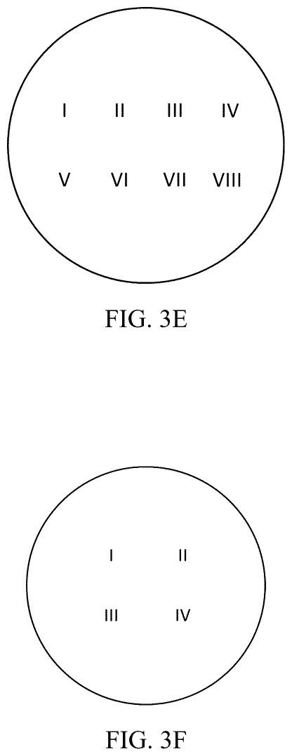

The heterogeneous multicore optical fibers of the present disclosure include two or more core elements of the types and variants thereof described in FIGS. 2A-2D. Various embodiments of heterogeneous multicore optical fibers are depicted in FIGS. 3A-3F. FIG. 3A shows a two-core (1×2) heterogeneous multicore fiber 10 that includes core elements 211 and 221 shown in FIGS. 2B and 2C. FIG. 3B shows a two-core (1×2) heterogeneous multicore fiber 10 that includes core elements 201 and 231 shown in FIGS. 2A and 2D. FIG. 3C shows a three-core heterogeneous multicore fiber 10 that includes core elements 201, 221, and 231 shown in FIGS. 2A, 2C, and 2D. Similar embodiments of heterogeneous multicore optical fibers using other combinations of two or more of the core elements depicted in FIGS. 2A-2D and variations thereof are within the scope of the present disclosure. FIGS. 3D-3F show additional examples of heterogeneous multicore optical fibers having four and eight core elements. In FIGS. 3D-3F, roman numerals (I, II, III, . . . ) depict positions of core elements, such as those depicted in FIGS. 2A-2D and variants thereof, where it is understood that not all core elements are identical. FIG. 3D depicts a four-core heterogeneous multicore optical fiber in which the core elements are arranged in a 1×4 configuration. FIG. 3E depicts a four-core heterogeneous multicore optical fiber in which the core elements are arranged in a 2×4 configuration. FIG. 3F depicts a four-core multicore optical fiber in which the core elements are arranged in a 2×2 configuration.

Other arrangements of core elements include N×M generally, where N and M are integers respectively representing the number of row and columns in the configuration of core elements, and polygonal (e.g., hexagonal).

The heterogeneous multicore optical fibers disclosed herein are advantageous when integrated in cables deployed at large bend radius because crosstalk between core elements is low due to differences in the propagation constant β (or effective index n_{eff}) of the core elements. The effective index is related to the phase velocity of a guided mode in an optical fiber. When two core elements have the same effective index, as in homogeneous multicore optical fibers, they have the same phase velocity and are at the phase-matched condition. At the phase-matched condition, crosstalk between the core elements is maximized because phase matching of the light coupled from one core element to the other core element leads to constructive interference of the optical signals in the two core elements when optical signals from the two core elements overlap.

In order to suppress crosstalk in homogeneous multicore optical fibers, a large core element spacing is needed. A large core element spacing, however, limits the number of cores that can be included in a homogeneous multicore optical fiber with a given diameter. The information capacity of homogeneous multicore optical fibers is accordingly limited. If two core elements differ in effective index, as occurs in heterogeneous multicore optical fibers, destructive interference of the optical signals in the two core elements occurs upon overlap of optical signals and crosstalk is reduced. The reduction in crosstalk increases as the difference between the effective indices of the two core elements increases. Accordingly, for a given level of crosstalk, smaller core element spacings, higher core element density, and higher information capacity are available for heterogeneous multicore optical fibers.

Crosstalk is also influenced by the bend radius of the multicore optical fiber in its deployment environment. For a homogeneous multicore optical fiber, crosstalk is highest for a linear deployment (infinite bend radius) and decreases with decreasing bend radius (tighter bending) when bent. If the bend radius is sufficiently small (e.g., in deployments such as data centers where compact installation is needed), crosstalk between core elements of homogeneous multicore optical fibers may be sufficiently low to provide suitable performance. In deployments with large bend radius (gradual bending such as commonly occurs with cable environments), crosstalk in homogeneous multicore optical fibers may be too high to be acceptable and alternative solutions may be needed.

The present disclosure extends to cables that include the heterogeneous multicore optical fibers disclosed herein. The cable includes a jacket or buffer tube into which one or more heterogeneous multicore optical fibers is disposed. The cable may be used for long distance transmission of optical signals and may extend in length for hundreds or thousands of miles. When disposed in a cable, the heterogeneous multicore optical fiber may be subjected to bending along the length of the cable. The bending is characterized by a bend radius, which corresponds to the radius of curvature associated with the bend. The bend radius may vary along the length of the cable. For purposes of the present disclosure, the term “bend radius” refers to the average bend radius of the heterogeneous multicore optical fiber along its deployment length.

The heterogeneous multicore optical fibers of the present disclosure are suitable for use in cables and other large bend radius deployment environments. The mismatch in propagation constant β (or effective index n_{eff}) between core elements of heterogeneous multicore optical fibers leads not only to a reduction in crosstalk relative to homogeneous multicore optical fibers, but also to a difference in the dependence of crosstalk on bend radius that especially favors heterogeneous multicore optical fibers in deployments with high bend radius. In homogeneous multicore optical fibers, crosstalk between core elements is low at small bend radius and monotonically increases to a maximum as bend radius increases. In heterogeneous multicore optical fibers, crosstalk between core elements is low at small bend radius, increases to a maximum at a critical bend radius R_{crit}, and decreases as bend radius increases above the critical bend radius R_{crit}. The critical bend radius R_{crit} depends on the mismatch in propagation constant β or effective index n_{eff} between core elements and is given by Eq. (7):

$${R}_{crit} = \frac{Λ {β}_{a v g}}{\vert Δβ \vert} = \frac{Λ {n}_{eff , avg}}{\vert Δ {n}_{eff} \vert} \qquad ( 7 )$$

where Λ is the core element spacing between core elements, β_{avg} is the average of the propagation constants β₁ and β₂ of the core elements, |Δβ| is the absolute value of the difference β₁-β₂ between the propagation constants β₁ and β₂, n_{eff,avg} is the average of the effective indices n_{eff,1} and n_{eff,2} of the core elements, and |Δn_{eff,avg}| is the absolute value of the difference n_{eff,1}-n_{eff,2} between the effective indices n_{eff,1} and n_{eff,2}. Eq. (7) was developed for a heterogeneous multicore optical fiber having two core elements and, without wishing to be bound by theory and when applied to the closest pair of adjacent core elements, is believed to provide a good approximation for the determination of the critical bend radius R_{crit} in heterogeneous multicore optical fibers having three or more core elements. Eq. (7) provides a guiding principle for designing heterogeneous multicore optical fibers. In particular, low crosstalk is expected for deployments of heterogeneous multicore optical fibers in which the bend radius is greater than the critical bend radius R_{crit} predicted by Eq. (7). Alternatively, if the bend radius of a particular deployment environment is known, Eq. (7) can be used to design core elements for a heterogeneous multicore optical fiber that provide a critical bend radius R_{crit} for the heterogeneous multicore optical fiber that is below the known bend radius of the deployment environment. Since the propagation constant of the core elements is the same in homogeneous multicore optical fibers, the critical bend radius of a homogeneous multicore optical fiber is infinite.

In addition to low crosstalk in large bend radius deployments, heterogeneous multicore optical fibers are also advantageous because they obviate the need for a marker element. Marker elements are commonly included in the common cladding of homogeneous multicore optical fibers to provide a fiducial for alignment. The need for an alignment fiducial arises because core elements in multicore optical fibers are commonly distributed symmetrically about the centerline of the multicore optical fiber. If core elements are identical and symmetrically distributed, it becomes impossible to determine the correspondence between core elements on opposite ends of the multicore optical fiber. Determination of the correspondence between core elements is needed for operations such as splicing, connecting, signal tracing, and maintaining signal polarity.

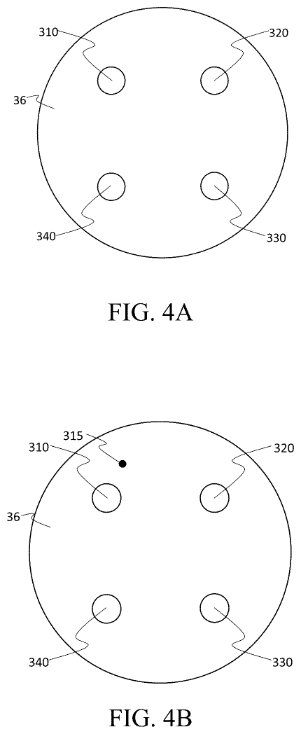

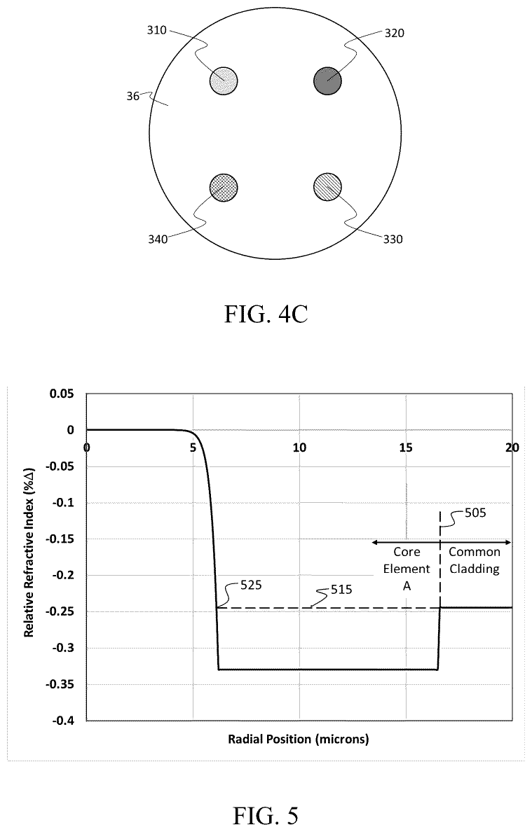

FIG. 4A shows a cross-section of a homogeneous multicore optical fiber with four core elements arranged in a 2×2 configuration in common cladding region 36. Core elements 310, 320, 330, and 340 are symmetrically disposed about the centerline of the homogeneous multicore fiber and are identical in composition, structure, and dimensions. Although depicted as single regions, it is understood that core elements 310, 320, 330, and 340 may include multiple regions as described above in FIGS. 2A-2D (e.g., one or more of a core region, dedicated inner cladding region, dedicated depressed index cladding region, and dedicated outer cladding region). When deployed in a cable, the homogeneous multicore optical fiber shown in FIG. 4A may extend for several hundred meters or kilometers within a jacket. During stranding or installation of the homogeneous multicore optical fiber in the jacket, the homogeneous multicore optical fiber may be subjected to twisting or rotation about the centerline. The extent of the twisting or rotation is typically not known and not readily determinable, so it is not possible to determine which core element at one end of the homogeneous multicore optical fiber shown in FIG. 4A corresponds to which core element at the opposite end of the homogeneous multicore optical fiber shown in FIG. 4A. To enable identification of core elements, a marker element is customarily included in homogeneous multicore optical fibers having a symmetric arrangement of core elements. FIG. 4B shows a variation of the homogeneous multicore optical fiber of FIG. 4A that includes marker element 315. Marker element 315 is disposed in common cladding region 36 and extends along the length of the homogeneous multicore optical fiber shown in FIG. 4B. The marker element is an alignment reference that is readily detectable at both ends of the homogeneous multicore optical fiber. It allows for identification and correspondence of core elements at the two ends of the fiber. The drawback with using a marker element as an alignment reference is the additional complexity it adds to the fiber manufacturing process. The marker element is an additional component that needs to be integrated into the common cladding region along with the core elements.

The need for marker elements as an alignment reference for core elements can be avoided when using heterogeneous multicore optical fibers. Heterogeneous multicore optical fibers include at least two core elements that differ with respect to composition, dimensions, or structure and such differences can be used to distinguish the different core elements of a heterogeneous multicore optical fiber in the absence of a marker element. Any asymmetric arrangement of core elements that differ in one or more of composition, dimensions, or structure enables determination of alignment and correspondence of core elements on opposite ends through inspection of the ends of the heterogeneous multicore optical fiber. An asymmetric arrangement is any arrangement of core elements that lacks rotational symmetry with respect to all angles of rotation about the centerline of the heterogeneous multicore optical fiber. FIG. 4C, for example, shows one of many possible examples of a heterogeneous variant of the homogeneous multicore optical fiber of FIG. 4A that does not require a marker element for determination of alignment. As in FIG. 4A, the heterogeneous core elements are arranged in a 2×2 configuration with the centerlines of the core elements symmetrically disposed about the centerline of the heterogeneous multicore optical fiber. Unlike FIG. 4A, the core elements depicted in FIG. 4C are not identical. Instead, each differs with respect to one of composition, dimensions, or structure relative to the others. Note that determination of alignment without a marker element does not require that all core elements of a heterogeneous multicore optical fiber be different from each other. In some embodiments, two or more core elements of a heterogeneous multicore optical fiber may be identical and differ in composition, dimensions, or structure from other core elements of the heterogeneous multicore optical fiber. A variant of the heterogeneous multicore optical fiber shown in FIG. 4C in which core elements 310, 320, and 330 are identical with each differing in composition, dimensions, or structure from core element 340, for example, would enable determination of alignment without a marker element through inspection of the ends of the heterogeneous multicore optical fiber.

Advantages of the heterogeneous multicore optical fibers disclosed herein are illustrated in the examples that follow, which are intended to be representative and non-limiting. In the examples, counterpropagating crosstalk as a function of bend radius is compared for a homogeneous multicore optical fiber and related heterogeneous multicore optical fibers.

### Example 1

FIG. 5 shows the relative refractive index profile for a core element, denoted “Core Element A”, and a common cladding region for a multicore optical fiber. Core Element A includes a core region with a step index profile (α=20) that is surrounded by and directly adjacent to a dedicated depressed index cladding region. The common cladding region surrounds and is directly adjacent to the dedicated depressed index cladding region. Core Element A lacks a dedicated inner cladding region and a dedicated outer cladding region. Dashed vertical line 505 marks the radial position corresponding to the interface between Core Element A and the common cladding region. Dashed horizontal line 515 represents an extrapolation of the relative refractive index Δ₄ of the common cladding region to smaller radius and defines a point 525 corresponding to the outer radius r₁ of the core region.

Table I shows the relative refractive index Δ₁ and radius r₁ of the core region; the relative refractive index Δ₃, inner radius r₁, and outer radius r₃ of the dedicated depressed index cladding region; and the relative refractive index Δ₄ of the common cladding region. Selected modeled optical attributes (propagation constant β at 1550 nm, cable cutoff wavelength, mode field diameter at 1550 nm, dispersion at 1550 nm, and dispersion slope at 1550 nm) are also listed for Core Element A when configured in a state isolated from other core elements in the common cladding region. Table I also includes similar information for Core Elements B, C, and D. Core Elements B, C, and D differ in the relative refractive index Δ₁ of the core region from Core Element A but are otherwise identical. The difference in the relative refractive index Δ₁ leads to a difference in propagation constant β. The relative refractive index Δ₁ is close to that of undoped silica for each of Core Elements A-D and is consistent with a core region of silica glass doped with an alkali metal. The negative relative refractive index of the dedicated depressed index cladding region can be realized by doping silica glass with fluorine.

TABLE I

| | Core Element | | | |
|---|---|---|---|---|
| | A | B | C | D |
| Δ₁ (%) | 0.000 | 0.010 | 0.020 | 0.030 |
| r₁ (μm) | 6.10 | 6.10 | 6.10 | 6.10 |
| Δ₃ (%) | −0.330 | −0.330 | −0.330 | −0.330 |
| r₃ (μm) | 16.50 | 16.50 | 16.50 | 16.50 |
| β at 1550 nm (nm⁻¹) | | | | |
| Cable Cutoff (nm) | 1413 | | | |
| A_{eff} at 1550 nm (μm²) | 110 | | | |
| Dispersion at 1550 nm | 20.9 | | | |
| (ps/nm/km) | | | | |
| Dispersion Slope at 1550 nm | 0.061 | | | |
| (ps/nm²/km) | | | | |

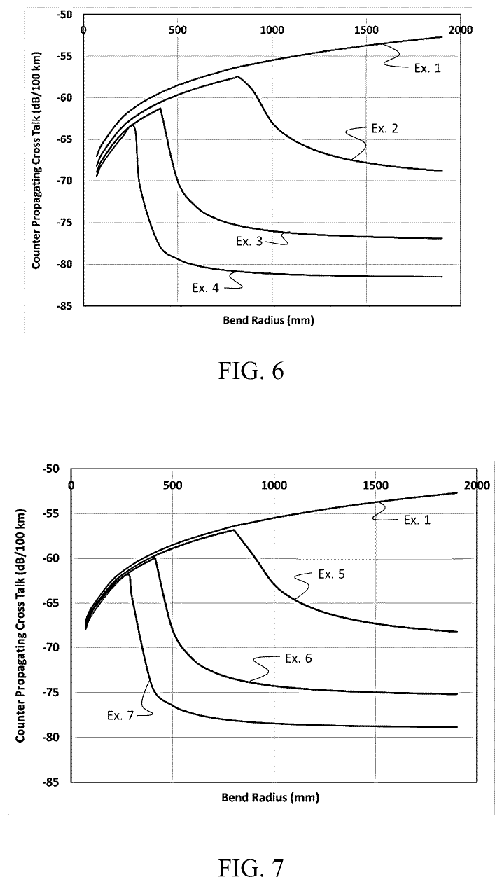

Counterpropagating crosstalk as a function of bend radius was modeled for four 1×2 multicore optical fibers (Ex. 1-Ex. 4) that included Core Elements A-D of Table I. Counterpropagating crosstalk is reported in units of dB (decibels) per 100 km of fiber length. Each 1×2 multicore optical fiber had a design of the type shown in FIG. 1B in which the two core elements were centered about the centerline of the multicore optical fiber with a core element spacing of 50 μm and the common cladding region had a relative refractive index Δ₄=−0.245% and a radius R₄=62.5 μm. Table II lists the configuration of Ex. 1-Ex. 4. Ex. 1 is a comparative homogeneous 1×2 multicore optical fiber that included two instances of Core Element A. Ex. 2 is a heterogeneous 1×2 multicore optical fiber that included Core Element A and Core Element B. Ex. 3 is a heterogeneous 1×2 multicore optical fiber that included Core Element A and Core Element C. Ex. 4 is a heterogeneous 1×2 multicore optical fiber that included Core Element A and Core Element D. Table II also lists the critical bend radius R_{crit} for each heterogeneous multicore optical fiber (Ex. 2-Ex. 4) as derived from the model used to construct FIG. 6.

TABLE II

Multicore Optical Fiber (1 × 2)

| | Ex. 1 | Ex. 2 | Ex. 3 | Ex. 4 |
|---|---|---|---|---|
| Core Element | A | A | A | A |
| Core Element | A | B | C | D |
| Core Element | 50 | 50 | 50 | 50 |
| Spacing (μm) | | | | |
| Δ₄ (%) | −0.245 | −0.245 | −0.245 | −0.245 |
| R₄ (μm) | 62.50 | 62.50 | 62.50 | 62.50 |
| R_{crit} (mm) | | 823 | 409 | 271 |

FIG. 6 shows counterpropagating crosstalk at 1550 nm as a function of bend radius for each of the examples listed in Table II based on the model presented in T. Hayashi, T. Nagashima, A. Inoue, H. Sakuma, T. Suganuma and T. Hasegawa, “Uncoupled Multi-Core Fiber Design for Practical Bidirectional Optical Communications”, Paper #MIE.1, Optical Fiber Communications Conference 2022 (2022). The homogeneous multicore optical fiber (Ex. 1) shows a continuous increase in counterpropagating crosstalk with increasing bend radius. The three heterogeneous multicore optical fibers (Ex. 2-Ex. 4), in contrast, show increases in counterpropagating crosstalk with increasing bend radius up to a critical bend radius and a decrease in counterpropagating crosstalk upon a further increase in bend radius. The critical bend radius differs for Ex. 2, Ex. 3, and Ex. 4 and increases as the difference in the propagation constant β of the two core elements decreases.

### Example 2

Additional examples Ex. 5-Ex. 7 of multicore optical fibers are presented in Table III, Table IV, and FIG. 7. Core Element A is repeated from above and additional description of Core Elements E, F, and G is provided. Core Elements E, F, and G differ in the radius r₁ of the core region from Core Element A but are otherwise identical. The difference in radius r₁ leads to a difference in propagation constant β.

TABLE III

| | Core Element | | | |
|---|---|---|---|---|
| | A | E | F | G |
| Δ₁ (%) | 0.000 | 0.000 | 0.000 | 0.000 |
| r₁ (μm) | 6.10 | 6.30 | 6.50 | 6.70 |
| Δ₃ (%) | −0.330 | −0.330 | −0.330 | −0.330 |
| r₃ (μm) | 16.50 | 16.50 | 16.50 | 16.50 |
| β at 1550 nm (nm⁻¹) | | | | |
| Cable Cutoff (nm) | 1413 | | | |
| A_{eff} at 1550 nm (μm²) | 110 | | | |
| Dispersion at 1550 nm | 20.9 | | | |
| (ps/nm/km) | | | | |
| Dispersion Slope at 1550 nm | 0.061 | | | |
| (ps/nm²/km) | | | | |

Counterpropagating crosstalk as a function of bend radius was modeled as described in Example 1 for four 1×2 multicore optical fibers (Ex. 1 and Ex. 5-Ex. 7) that included Core Elements A and E-G of Table III. Counterpropagating crosstalk is reported in units of dB (decibels) per 100 km of fiber length. Each 1×2 multicore optical fiber had a design of the type shown in FIG. 1B in which the two core elements were centered about the centerline of the multicore optical fiber with a core element spacing of 50 μm and the common cladding region had a relative refractive index Δ₄=−0.245% and a radius R₄=62.5 μm. Table IV lists the configuration of Ex. 1 and Ex. 5-Ex. 7. Ex. 1 is a comparative homogeneous 1×2 multicore optical fiber that included two instances of Core Element A as described above. Ex. 5 is a heterogeneous 1×2 multicore optical fiber that included Core Element A and Core Element E. Ex. 6 is a heterogeneous 1×2 multicore optical fiber that included Core Element A and Core Element F. Ex. 7 is a heterogeneous 1×2 multicore optical fiber that included Core Element A and Core Element G. Table IV also lists the critical bend radius R_{crit} for each heterogeneous multicore optical fiber (Ex. 5-Ex. 7) as derived from the model used to construct FIG. 7.

TABLE IV

Multicore Optical Fiber (1 × 2)

| | Ex. 1 | Ex. 5 | Ex. 6 | Ex. 7 |
|---|---|---|---|---|
| Core Element | A | A | A | A |
| Core Element | A | E | F | G |
| Core Element | 50 | 50 | 50 | 50 |
| Spacing (μm) | | | | |
| Δ₄ (%) | −0.245 | −0.245 | −0.245 | −0.245 |
| R₄ (μm) | 62.50 | 62.50 | 62.50 | 62.50 |
| R_{crit} (mm) | | 802 | 414 | 284 |

FIG. 7 shows counterpropagating crosstalk at 1550 nm as a function of bend radius for each of the examples listed in Table IV based on the model described in Example 1. The homogeneous multicore optical fiber (Ex. 1) shows a continuous increase in counterpropagating crosstalk with increasing bend radius. The three heterogeneous multicore optical fibers (Ex. 5-Ex. 7), in contrast, show increases in counterpropagating crosstalk with increasing bend radius up to a critical bend radius and a decrease on counterpropagating crosstalk upon a further increase in bend radius. The critical bend radius differs for Ex. 5, Ex. 6, and Ex. 7 and increases as the difference in the propagation constant β of the two core elements decreases.

### Example 3

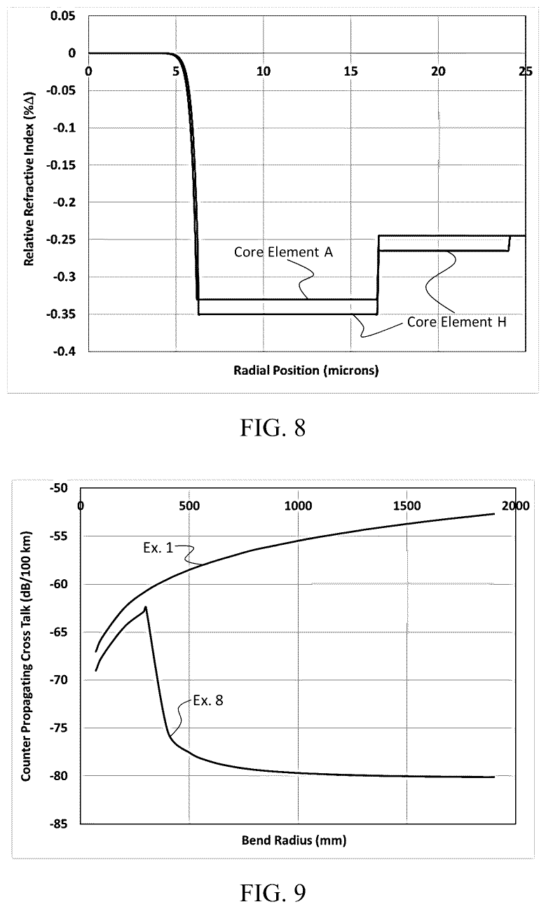

An additional example Ex. 8 of a multicore optical fiber is presented in Table V, Table VI, FIG. 8, and FIG. 9. Core Element A is repeated from above and additional description of Core Element H is provided. FIG. 8 shows the relative refractive index profiles of Core Element A and Core Element H. Core Element H includes a core region with a step index profile (α=20) that is surrounded by and directly adjacent to a dedicated depressed index cladding region, which is surrounded by and directly adjacent to a dedicated outer cladding region. The common cladding region surrounds and is directly adjacent to the dedicated outer cladding region. Core Element H has a slightly larger radius r₁ of the core region than Core Element A and includes a slightly lower relative refractive index Δ₃ for the dedicated depressed index cladding region. In Core Element A, the common cladding region extends from the outer radius r₃ of the dedicated depressed index cladding region to the boundary of the glass fiber. Core Element H includes a dedicated outer cladding region with relative refractive index Δ_{4doc} that extends from the outer radius r₃ of the dedicated depressed index cladding region to the radius r₄. The common cladding region surrounding core Element H extends from the radius r₄ to the boundary of the glass fiber. Core Element H differs in the radius r₁ of the core region, the relative refractive index Δ₃, and the presence of a dedicated outer cladding region from Core Element A. The outer radius r₄ of Core Element H is larger than the outer radius r₃ of Core Element A. These differences lead to a difference in propagation constant β.

TABLE V

Core Element

| | A | H |
|---|---|---|
| Δ₁ (%) | 0.000 | 0.000 |
| r₁ (μm) | 6.10 | 6.25 |
| Δ₃ (%) | −0.330 | −0.350 |
| r₃ (μm) | 16.50 | 16.50 |
| Δ_{4doc} (%) | | −0.265 |
| r₄ (μm) | | 24.00 |
| β at 1550 nm (nm−¹) | | |
| Cable Cutoff (nm) | 1413 | 1484 |
| A_{eff} at 1550 nm (μm²) | 110 | 110 |
| Dispersion at 1550 nm | 20.9 | 21.2 |
| (ps/nm/km) | | |
| Dispersion Slope at 1550 nm | 0.061 | 0.061 |
| (ps/nm²/km) | | |

Counterpropagating crosstalk as a function of bend radius was modeled as described in Example 1 for two 1×2 multicore optical fibers (Ex. 1 and Ex. 8) that included Core Elements A and H of Table V. Counterpropagating crosstalk is reported in units of dB (decibels) per 100 km of fiber length. Each 1×2 multicore optical fiber had a design of the type shown in FIG. 1B in which the two core elements were centered about the centerline of the multicore optical fiber with a core element spacing of 50 μm and the common cladding region had a relative refractive index Δ₄=−0.245% and a radius R₄=62.5 μm. Table VI lists the configurations of Ex. 1 and Ex. 8. Ex. 1 is a comparative homogeneous 1×2 multicore optical fiber that included two instances of Core Element A as described above. Ex. 8 is a heterogeneous 1×2 multicore optical fiber that included Core Element A and Core Element H. Table VI also lists the critical bend radius R_{crit} for the heterogeneous multicore optical fiber (Ex. 8) as derived from the model used to construct FIG. 9.

TABLE VI

Multicore Optical Fiber (1 × 2)

| | Ex. 1 | Ex. 8 |
|---|---|---|
| Core Element | A | A |
| Core Element | A | H |
| Core Element | 50 | 50 |
| Spacing (μm) | | |
| Δ₄ (%) | −0.245 | −0.245 |
| R₄ (μm) | 62.50 | 62.50 |
| R_{crit} (mm) | | 291 |

FIG. 9 shows counterpropagating crosstalk at 1550 nm as a function of bend radius for each of the examples listed in Table VI based on the model described in Example 1. The homogeneous multicore optical fiber (Ex. 1) shows a continuous increase in counterpropagating crosstalk with increasing bend radius. The heterogeneous multicore optical fiber (Ex. 8), in contrast, shows an increase in counterpropagating crosstalk with increasing bend radius up to a critical bend radius R_{crit} and a decrease on counterpropagating crosstalk upon a further increase in bend radius.

### Example 4

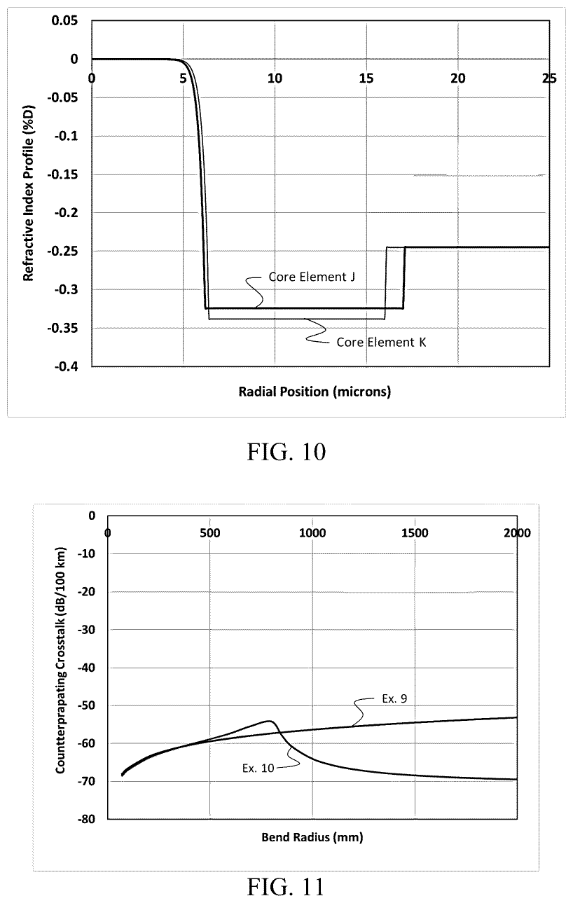

Additional examples Ex. 9 and Ex. 10 of multicore optical fibers are presented in Table VII, Table VII, FIG. 10, and FIG. 11. Descriptions of Core Element J and Core Element K are provided. FIG. 10 shows the relative refractive index profiles of Core Element J and Core Element K. Core Element J includes a core region with a step index profile (α=20) that is surrounded by and directly adjacent to a dedicated depressed index cladding region. A common cladding region surrounds and is directly adjacent to the dedicated depressed index cladding region. Core Element K includes a core region with a step index profile (α=20) that is surrounded by and directly adjacent to a dedicated depressed index cladding region. The common cladding region surrounds and is directly adjacent to the dedicated depressed index cladding region. Core Element K has a slightly larger radius r₁ of the core region than Core Element J and includes a slightly lower relative refractive index Δ₃ for the dedicated depressed index cladding region. Core Element K also has a smaller width r₃-r₁ of the dedicated depressed index cladding region than Core Element J. These differences lead to a difference in propagation constant β.

TABLE VII

Core Element

| | J | K |
|---|---|---|
| Δ₁ (%) | 0.000 | 0.000 |
| r₁ (μm) | 6.10 | 6.30 |
| Δ₃ (%) | −0.324 | −0.338 |
| r₃ (μm) | 17.00 | 16.00 |
| β at 1550 nm (nm⁻¹) | | |
| Cable Cutoff (nm) | | |
| A_{eff} at 1550 nm (μm²) | | |
| Dispersion at 1550 nm | | |
| (ps/nm/km) | | |
| Dispersion Slope at 1550 nm | | |
| (ps/nm²/km) | | |

Counterpropagating crosstalk as a function of bend radius was modeled as described in Example 1 for two 1×2 multicore optical fibers (Ex. 9 and Ex. 10) that included Core Elements J and K of Table VII. Counterpropagating crosstalk is reported in units of dB (decibels) per 100 km of fiber length. Each 1×2 multicore optical fiber had a design of the type shown in FIG. 1B in which the two core elements were centered about the centerline of the multicore optical fiber with a core element spacing of 50 μm and the common cladding region had a relative refractive index Δ₄=−0.245% and a radius R₄=62.5 μm. Table VIII lists the configurations of Ex. 9 and Ex. 10. Ex. 9 is a comparative homogeneous 1×2 multicore optical fiber that included two instances of Core Element J as described above. Ex. 10 is a heterogeneous 1×2 multicore optical fiber that included Core Element J and Core Element K. Table VIII also lists the critical bend radius R_{crit} for the heterogeneous multicore optical fiber (Ex. 10) as derived from the model used to construct FIG. 11.

TABLE VIII

Multicore Optical Fiber (1 × 2)

| | Ex. 9 | Ex. 10 |
|---|---|---|
| Core Element | J | J |
| Core Element | J | K |
| Core Element | 50 | 50 |
| Spacing (μm) | | |
| Δ₄ (%) | −0.245 | −0.245 |
| R₄ (μm) | 62.50 | 62.50 |
| R_{crit} (mm) | | 800 |

FIG. 11 shows counterpropagating crosstalk at 1550 nm as a function of bend radius for each of the examples listed in Table VIII based on the model described in Example 1. The homogeneous multicore optical fiber (Ex. 9) shows a continuous increase in counterpropagating crosstalk with increasing bend radius. The heterogeneous multicore optical fiber (Ex. 10), in contrast, shows an increase in counterpropagating crosstalk with increasing bend radius up to a critical bend radius R_{crit} and a decrease on counterpropagating crosstalk upon a further increase in bend radius.

As illustrated in the foregoing examples and discussion, at least two of the core elements of the present heterogeneous multicore optical fibers differ in one or more of core region radius r₁, dedicated inner cladding radius r₂, dedicated depressed index cladding region radius r₃, dedicated outer cladding radius r₄, relative refractive index Δ₁ of the core region, relative refractive index Δ₂ of a dedicated inner cladding region, relative refractive index Δ₃ of a dedicated depressed index cladding region, relative refractive index Δ_{4doc} of a dedicated outer cladding region, a core profile (step index vs. graded index or differences in the parameter α), and number and type of dedicated cladding regions.

Differences in a and Δ₁, Δ₂, Δ₃, and Δ_{4doc} are achievable through differences in composition, dopant concentration, spatial distribution of dopant, and/or dopant type.

Differences in r₁, r₂, r₃, and r₄ are achievable by controlling the thicknesses of regions in a preform corresponding to the core region, dedicated inner cladding region, dedicated depressed index cladding region, and dedicated outer cladding region.

The difference(s) leads (lead) to a difference in propagation constant β for the at least two core elements, which in turn establishes a critical bend radius R_{crit} for the multicore optical fiber.

The core regions of the core elements of the multicore optical fiber preferably comprise silica glass. Silica glass includes undoped silica glass, updoped silica glass, and/or downdoped silica glass. Updoped silica glass includes silica glass doped with one or more of GeO₂, an alkali metal oxide (e.g., Na₂O, K₂O, Li₂O, Cs₂O, or Rb₂O) or a halogen (e.g., Cl, Br). In embodiments, the concentration of GeO₂ in silica glass is from 5 wt % to 22 wt %, or 7 wt % to 15 wt %.

Downdoped silica glass includes silica glass doped with one or more of F or B. The concentration of K₂O in certain embodiments of the core regions, expressed in terms of the amount of K, is in the range from 20 ppm-1000 ppm, or 35 ppm-500 ppm, or 50 ppm-300 ppm, where ppm refers to parts per million by weight. Alkali metal oxides other than K₂O may be present in amounts corresponding to the equivalent molar amount of K₂O as determined from the amount of K indicated above in other embodiments. The concentration of Cl or Br in some embodiments of the core regions is in the range from 0.5 wt %-6.0 wt %, or in the range from 1.0 wt %-5.5 wt %, or in the range from 1.5 wt %-5.0 wt %, or in the range from 2.0 wt %-4.5 wt %, or in the range from 2.5 wt %-4.0 wt %. The dopant type and/or dopant concentration in the core regions of different core elements of the multicore glass fiber are the same or different.

In different embodiments, the relative ordering of relative refractive indices of the core elements shown in FIGS. 2A-2D satisfy the conditions Δ₁ (or Δ₁ₘₐₓ)>Δ_{4doc}>Δ₃ (or Δ₃ₘᵢₙ), Δ₁ (or Δ₁ₘₐₓ)>Δ₂>Δ₃ (or Δ₃ min), Δ₁ (or Δ₁ₘₐₓ)>Δ_{4doc}>Δ₂, Δᵢ (or Δ₁ₘₐₓ)>Δ₂>Δ_{4doc}. The values of Δ₂ and Δ_{4doc} may be equal or either may be greater than the other, but both Δ₂ and Δ_{4doc} are between Δ₁ (or Δ₁ₘₐₓ) and Δ₃ (or Δ₃ₘᵢₙ) and are preferably also between Δ₁ (or Δ₁ₘₐₓ) and Δ₄.

In some embodiments, the relative refractive index of the core region of at least one core element of the multicore optical fiber is described by an α-profile with a profile parameter α in the range from 1.5-10, or in the range from 1.7-8.0, or in the range from 1.8-6.0, or in the range from 1.9-5.0, or in the range from 2.0-4.0, or in the range from 10-50, or in the range from 11-40, or in the range from 12-30.

In an embodiment, a difference in propagation constant β between two core elements of a multicore optical fiber is accomplished through a difference in the profile parameter α. A difference in profile parameter α between the core region of one core element and the core region of another core element of the multicore optical fiber is greater than 0.5, or greater than 1.0, or greater than 2.0, or greater than 5.0, or less than 50, or less than 40, or less than 30, or less than 20, or combinations thereof (e.g., greater than 0.5 and less than 50, etc.), or in the range from 0.5 to 50, or in the range from 0.5 to 30, or in the range from 0.5 to 10, or in the range from 1.0 to 50, or in the range from 1.0 to 30, or in the range from 1.0 to 10. In other embodiments, the profile parameter α is the same for the core regions of two core elements and a difference in propagation constant β between two core elements of a multicore optical fiber is accomplished through a difference in an attribute of a feature or region other than the profile parameter α (e.g., radius, thickness, relative refractive index, number and type of dedicated cladding regions).

The outer radius r₁ of the core region of each core element of the multicore optical fiber is in the range from 3.0 μm-9.0 μm, or in the range from 3.0 μm-8.0 μm, or in the range from 3.0 μm-7.5 μm, or in the range from 3.5 μm-7.0 μm.

In an embodiment, a difference in propagation constant β between two core elements of a multicore optical fiber is accomplished through a difference in the outer radius rᵢ of the core region of the two core elements. A difference r_{1,1}−r_{1,2} in outer radius r_{1,1} between the core region of a first core element and the outer radius r_{1,2} of the core region of a second core element of the multicore optical fiber is greater than 0.05 μm, or greater than 0.10 μm, or greater than 0.15 μm, or greater than 0.20 μm, or greater than 0.25 μm, or greater than 0.30 μm, or greater than 0.35 μm, or less than 0.60 μm, or less than 0.55 μm, or less than 0.50 μm, or less than 0.45 μm, or combinations thereof (e.g., greater than 0.15 μm and less than 0.60 μm, etc.), or in the range from 0.05 μm to 0.60 μm, or in the range from 0.05 μm to 0.45 μm, or in the range from 0.10 μm to 0.60 μm, or in the range from 0.10 μm to 0.45 μm. In other embodiments, the outer radius r₁ is the same for the core regions of two core elements and a difference in propagation constant β between the two core elements of a multicore optical fiber is accomplished through a difference in an attribute of a feature or region other than the outer radius r₁ of the core region (e.g., profile parameter α, radius, thickness, relative refractive index, number and type of dedicated cladding regions).

The relative refractive index Δ₁ or Δ₁ₘₐₓ of the core region of each core element of the multicore optical fiber is in the range from −0.20% to 0.50%, or in the range from −0.15% to 0.30%, or in the range from −0.10% to 0.20%, or in the range from −0.10% to 0.10%, or in the range from −0.05% to 0.10%, or in the range from −0.05% to 0.05%.

In an embodiment, a difference in propagation constant β between two core elements of a multicore optical fiber is accomplished through a difference in the relative refractive index Δ₁ (or Δ₁ₘₐₓ) of the core region of the two core elements. A difference Δ_{1,1}−Δ_{1,2} (or Δ_{1max,1}-Δ_{1max,2}) between the relative refractive index Δ_{1,1} (or Δ_{1max,1}) of the core region of a first core element and the relative refractive index Δ_{1,2} (or Δ_{1max,2}) of the core region of a second core element of a multicore optical fiber is greater than 0.005%, or greater than 0.01%, or greater than 0.02%, or greater than 0.03%, or greater than 0.05%, or greater than 0.10%, or less than 0.20%, or less than 0.15%, or less than 0.10%, or less than 0.05%, or combinations thereof (e.g., greater than 0.02% and less than 0.10%, etc.), or in the range from 0.01%-0.20%, or in the range from 0.02%-0.15%, or in the range from 0.03%-0.10%. In other embodiments, the relative refractive index Δ₁ (or Δ₁ₘₐₓ) of the core region of the two core elements is the same for the core regions of two core elements and a difference in propagation constant β between the two core elements of a multicore optical fiber is accomplished through a difference in an attribute of a feature or region other than the relative refractive index Δ₁ (or Δ₁ₘₐₓ) of the core region (e.g., profile parameter α, radius, thickness, relative refractive index, number and type of dedicated cladding regions).

In embodiments in which the core region of at least one core element of the multicore optical fiber is directly adjacent to a dedicated inner cladding region, the relative refractive index Δ₂ or Δ₂ₘₐₓ or Δ₂ₘᵢₙ of the dedicated inner cladding region is less than 0.10%, or less than 0.05%, or less than 0.00%, or less than −0.05%, or less than −0.10%, or less than −0.15%, or less than −0.20%, or less than −0.25%, or greater than −0.40%, or greater than −0.35%, or greater than −0.30%, or combinations thereof (e.g., less than −0.05% and greater than −0.30%), or in the range from −0.40% to 0.10%, or in the range from −0.35% to 0.05%, or in the range from −0.30% to 0.00%, or in the range from −0.25% to −0.05%, or in the range from −0.25% to −0.10%, or in the range from −0.10% to 0.10%, or in the range from −0.05% to 0.05%.

In embodiments in which at least one core region of the multicore glass fiber is directly adjacent to a dedicated inner cladding region, the radius r₂ of a dedicated inner cladding region is in the range from 4.0 μm-12.0 μm, or in the range from 4.5 μm-10.0 μm, or in the range from 5.0 μm-9.0 μm. The thickness r₂−r₁ of the inner cladding region is in the range from 0.1 μm-4.0 μm, or in the range from 0.5 μm-3.5 μm, or in the range from 1.0 μm-3.0 μm.

In embodiments in which the core region of two or more core elements of the multicore optical fiber is directly adjacent to a dedicated inner cladding region, the value of Δ₂ (or Δ₂ₘₐₓ or Δ₂ min), the value of r₂, and/or the thickness r₂−r₁ for dedicated inner cladding regions of core regions of different core elements is the same or different.

In an embodiment, a difference in propagation constant β between two core elements of a multicore optical fiber is accomplished by including a dedicated inner cladding region in one of the core elements and not including a dedicated inner cladding region in the other core element. In another embodiment, a difference in propagation constant β between two core elements of a multicore optical fiber is accomplished by including a dedicated inner cladding region in each of the two core elements and configuring the dedicated inner cladding regions to differ in outer radius r₂, thickness r₂−r₁, or relative refractive index Δ₂.

In embodiments in which the core region of at least one core element of the multicore optical fiber includes a dedicated depressed index cladding region, the dedicated depressed index cladding region comprises downdoped silica glass. The preferred downdopant is F. The concentration of F is in the range from 0.1 wt %-2.0 wt %, or in the range from 0.3 wt %-1.8 wt %, or in the range from 0.5 wt %-1.5 wt %, or in the range from 0.7 wt % to 1.3 wt %.

In one embodiment, a dedicated depressed index cladding region surrounds and is directly adjacent to the core region of a core element. In another embodiment, a dedicated depressed index cladding region surrounds and is directly adjacent to a dedicated inner cladding region, which surrounds and is directly adjacent to the core region of a core element.

In embodiments in which at least one core element includes a dedicated depressed index cladding region, the relative refractive index Δ₃ (or Δ₃ min) is less than −0.20%, or less than −0.25%, or less than −0.30%, or less than −0.35%, or less than −0.40%, or less than −0.45%, or greater than −0.60%, or greater than −0.55%, or greater than −0.50%, or combinations thereof (e.g., less than −0.20% and greater than −0.50%), or in the range from −0.60% to −0.20%, or in the range from −0.50% to −0.20%, or in the range from −0.45% to −0.25%, or in the range from −0.40% to −0.30%. The relative refractive index Δ₃ is preferably constant or approximately constant.

In embodiments in which a core region of at least one core element is directly adjacent to a dedicated inner cladding region that is directly adjacent to a dedicated depressed index cladding region, the inner radius of the dedicated depressed index cladding region is r₂ and has the values specified above. The outer radius r₃ of the dedicated depressed index cladding region is in the range from 10.0 μm to 25.0 μm, or in the range from 12.5 μm-22.5 μm, or in the range from 15.0 μm-20.0 μm and the thickness r₃-r₂ of the dedicated depressed index cladding region is in the range from 5.0 μm-15.0 μm, or in the range from 6.0 μm-14.0 μm, or in the range from 7.0 μm-13.0 μm, or in the range from 8.0 μm-12.0 μm.

In embodiments in which the core region of two or more core elements of the multicore optical fiber is directly adjacent to a dedicated inner cladding region that is directly adjacent to a dedicated depressed index cladding region, the value of Δ₃ (or Δ₃ₘₐₓ or Δ₃ₘᵢₙ), the value of r₃, and/or the thickness r₃-r₂ for dedicated depressed index cladding regions of different core elements is the same or different.

In embodiments in which the core region of at least one core element is directly adjacent to a dedicated depressed index cladding region, the inner radius of the dedicated depressed index cladding region is r₁ and has the values specified above. The outer radius r₃ of the dedicated depressed index cladding region is in the range from 10.0 μm to 25.0 μm, or in the range from 12.5 μm-22.5 μm, or in the range from 15.0 μm-20.0 μm and the thickness r₃-r₁ of the dedicated depressed index cladding region is in the range from 5.0 μm-15.0 μm, or in the range from 6.0 μm-14.0 μm, or in the range from 7.0 μm-13.0 μm, or in the range from 8.0 μm-12.0 μm.

In embodiments in which the core region of two or more core elements of the multicore optical fiber is directly adjacent to a dedicated depressed index cladding region, the value of Δ₃ (or Δ₃ₘₐₓ or Δ₃ₘᵢₙ), the value of r₃, and/or the thickness r₃-r₁ for dedicated depressed index cladding regions of different core elements is the same or different

In an embodiment, a difference in propagation constant β between two core elements of a multicore optical fiber is accomplished by including a dedicated depressed index cladding region in one of the core elements and not including a dedicated depressed index cladding region in the other core element. In another embodiment, a difference in propagation constant β between two core elements of a multicore optical fiber is accomplished by including a dedicated depressed index cladding region in each of the two core elements and configuring the dedicated depressed index cladding regions to differ in outer radius r₃, thickness r₃-r₂ (or r₃-r₁) or relative refractive index Δ₃ (or Δ₃ₘₐₓ or Δ₃ₘᵢₙ).

In one embodiment, a difference in propagation constant β between two core elements of a multicore optical fiber is accomplished by including a dedicated depressed index cladding region in each of the two core elements and configuring the dedicated depressed index cladding regions to differ in outer radius r₃. A difference r_{3,1}−r_{3,2} in outer radius r_{3,1} between the depressed index cladding region of a first core element and the outer radius r_{3,2} of the depressed index cladding region of a second core element of the multicore optical fiber is greater than 0.25 μm, or greater than 0.50 μm, or greater than 0.75 μm, or greater than 1.00 μm, or greater than 1.50 μm, or greater than 2.00 μm, or greater than 2.50 μm, or less than 5.00 μm, or less than 4.00 μm, or less than 3.50 μm, or less than 3.00 μm, or combinations thereof (e.g., greater than 0.25 μm and less than 3.00 μm, etc.), or in the range from 0.25 μm to 5.00 μm, or in the range from 0.50 μm to 4.00 μm, or in the range from 0.75 μm to 3.50 μm, or in the range from 1.00 μm to 2.00 μm. In other embodiments, the outer radius r₃ is the same for the core regions of two core elements and a difference in propagation constant β between the two core elements of a multicore optical fiber is accomplished through a difference in an attribute of a feature or region other than the outer radius r₃ of the depressed index cladding region (e.g., profile parameter α, radius, thickness, relative refractive index, number and type of dedicated cladding regions).

In another embodiment, a difference in propagation constant β between two core elements of a multicore optical fiber is accomplished by including a dedicated depressed index cladding region in each of the two core elements and configuring the dedicated depressed index cladding regions to differ in thickness r₃−r₂ (or r₃−r₁). A difference (r_{3,1}−r_{2,1})−(r_{3,2}−r_{2,2}) (or (r_{3,1}−r_{1,1})−(r_{3,2}−r_{1,2})) in thickness r_{3,1}−r_{2,1} (or r_{3,1}−r_{1,1}) between the depressed index cladding region of a first core element and the thickness r_{3,2}−r_{2,2} (or r_{3,2}−r_{1,2}) of the depressed index cladding region of a second core element of the multicore optical fiber is greater than 0.25 μm, or greater than 0.50 μm, or greater than 0.75 μm, or greater than 1.00 μm, or greater than 1.50 μm, or greater than 2.00 μm, or greater than 2.50 μm, or less than 5.00 μm, or less than 4.00 μm, or less than 3.50 μm, or less than 3.00 μm, or combinations thereof (e.g., greater than 0.25 μm and less than 3.00 μm, etc.), or in the range from 0.25 μm to 5.00 μm, or in the range from 0.50 μm to 4.00 μm, or in the range from 0.75 μm to 3.50 μm, or in the range from 1.00 μm to 2.00 μm. In other embodiments, the r₃−r₂ (or r₃−rᵢ) is the same for the depressed index cladding regions of two core elements and a difference in propagation constant β between the two core elements of a multicore optical fiber is accomplished through a difference in an attribute of a feature or region other than the thickness r₃−r₂ (or r₃−r₁) of the depressed index cladding region (e.g., profile parameter α, radius, thickness, relative refractive index, number and type of dedicated cladding regions).

In another embodiment, a difference in propagation constant β between two core elements of a multicore optical fiber is accomplished by including a dedicated depressed index cladding region in each of the two core elements and configuring the dedicated depressed index cladding regions to differ in relative refractive index Δ₃ (or Δ₃ₘₐₓ or Δ₃ₘᵢₙ). A difference Δ_{3,1}−Δ_{3,2} (or Δ_{3min,1}−Δ_{3min,2}) between the relative refractive index Δ_{3,1} (or Δ_{3min,1}) of the depressed index cladding region of a first core element and the relative refractive index Δ_{3,2} (or Δ_{3min,2}) of the depressed index cladding region of a second core element of a multicore optical fiber is greater than 0.005%, or greater than 0.01%, or greater than 0.02%, or greater than 0.03%, or greater than 0.05%, or greater than 0.10%, or less than 0.20%, or less than 0.15%, or less than 0.10%, or less than 0.05%, or combinations thereof (e.g., greater than 0.02% and less than 0.10%, etc.), or in the range from 0.01%-0.20%, or in the range from 0.02%-0.15%, or in the range from 0.03%-0.10%. In other embodiments, the relative refractive index Δ₃ (or Δ₃ min) of the depressed index cladding region of the two core elements is the same for the depressed index cladding regions of the two core elements and a difference in propagation constant β between the two core elements of a multicore optical fiber is accomplished through a difference in an attribute of a feature or region other than the relative refractive index Δ₃ (or Δ₃ min) of the depressed index cladding region (e.g., profile parameter α, radius, thickness, relative refractive index, number and type of dedicated cladding regions).

In embodiments in which a core element includes a dedicated outer cladding region that surrounds and is directly adjacent to a dedicated depressed index cladding region, the inner radius of the outer cladding region is r₃ and has the values specified above. The outer radius r₄ of the dedicated outer cladding region is in the range from 15.0 μm to 30.0 μm, or in the range from 17.5 μm-27.5 μm, or in the range from 20.0 μm-25.0 μm and the thickness r₄−r₃ of the dedicated outer cladding region is in the range from 3.0 μm-12.0 μm, or in the range from 4.0 μm-11.0 μm, or in the range from 5.0 μm-10.0 μm, or in the range from 6.0 μm-9.0 μm.

In embodiments in which a core element includes a dedicated outer cladding region that surrounds and is directly adjacent to a dedicated depressed index cladding region, the relative refractive index Δ_{4doc} is less than −0.15%, or less than −0.20%, or less than −0.25%, or less than −0.30%, or less than −0.35%, or greater than −0.55%, or greater than −0.50%, or greater than −0.45%, or combinations thereof (e.g., less than −0.20% and greater than −0.50%), or in the range from −0.50% to −0.15%, or in the range from −0.45% to −0.20%, or in the range from −0.40% to −0.25%, or in the range from −0.35% to −0.25%. The relative refractive index Δ_{4doc} is preferably constant or approximately constant and is preferably greater than the relative refractive index Δ₃ (or Δ₃ min) of the depressed index cladding region and less than the relative refractive index Δ₄ of the common cladding region.

In an embodiment, a difference in propagation constant β between two core elements of a multicore optical fiber is accomplished by including a dedicated outer cladding region in one of the core elements and not including a dedicated outer cladding region in the other core element. In another embodiment, a difference in propagation constant β between two core elements of a multicore optical fiber is accomplished by including a dedicated outer cladding region in each of the two core elements and configuring the dedicated outer cladding regions to differ in outer radius r₄, thickness r₄−r₃, or relative refractive index Δ_{44doc}.

As noted in FIGS. 2A-2D and as described above, core elements of the multicore optical fiber include a core region and a dedicated cladding region but may differ in the number and type of dedicated cladding regions. Each of the core elements, for example, may or may not include a dedicated inner cladding region, may or may not include a dedicated depressed index cladding region, and may or may not include a dedicated outer cladding region. The radius of a core element is denoted herein as “r_{CE}” and corresponds to the radial position, relative to the centerline of the core element, at which the common cladding region directly contacts the core element. Depending on the configuration of the core element (e.g., the number and type of dedicated cladding regions), the core element radius r_{CE} corresponds to r₂, r₃, or r₄. Irrespective of the configuration of core elements, different core elements may have the same or different value of the core element radius r_{CE}.

In one embodiment, a difference in propagation constant β between two core elements of a multicore optical fiber is accomplished by configuring the core elements to differ in core element radius r_{CE}. A difference r_{CE,1}−r_{CE,2} in core element radius r_{CE,1} between a first core element and the core element radius r_{CE,2} of a second core element of the multicore optical fiber is greater than 0.50 μm, or greater than 1.00 μm, or greater than 1.50 μm, or greater than 2.00 μm, or greater than 2.50 μm, or greater than 3.00 μm, or less than 6.00 μm, or less than 5.50 μm, or less than 5.00 μm, or less than 4.50 μm, or combinations thereof (e.g., greater than 0.50 μm and less than 5.00 μm, etc.), or in the range from 0.50 μm to 6.00 μm, or in the range from 1.00 μm to 5.50 μm, or in the range from 1.50 μm to 5.00 μm, or in the range from 2.00 μm to 4.00 μm. In other embodiments, the core element radius r_{CE} is the same for the two core elements and a difference in propagation constant β between the two core elements of a multicore optical fiber is accomplished through a difference in an attribute of a feature or region other than the core element radius r_{CE} of the core element (e.g., profile parameter α, radius, thickness, relative refractive index, number and type of dedicated cladding regions).

The relative refractive index Δ₄ (or Δ₄ₘₐₓ) of the common cladding region is in the range from −0.40% to 0.10%, or in the range from −0.35% to 0.00%, or in the range from −0.35% to −0.10%, or in the range from −0.30% to −0.10%. The relative refractive index Δ₄ is preferably constant or approximately constant.

The outer radius R₄ of a common cladding region is less than 125.0 μm, or less than 100.0 μm, or less than 80.0 μm, or less than 65.0 μm, or less than 62.5 μm, or less than 60.0 μm, or less than 57.5 μm or less than 55.0 μm, or less than 52.5 μm or in the range from 50.0 μm-125.0 μm, or in the range from 55.0 μm-100.0 μm, or in the range from 57.5 μm-80.0 μm, or in the range from 60.0 μm-70.0 μm, or in the range from 50.0 μm-60.0 μm.

An effective area Δ_{eff} at a wavelength of 1550 nm of at least one core element of the multicore optical fiber is greater than 70 μm², or greater than 90 μm², or greater than 100 μm², or greater than 110 μm², or greater than 120 μm², or greater than 130 μm², or greater than 140 μm², or in the range from 70 μm²-160 μm², or in the range from 80 μm²-150 μm², or in the range from 90 μm²-140 μm², or in the range from 100 μm²-130 μm².

To facilitate splicing, connecting, and interfacing with existing infrastructure, it is desirable in some embodiments for the effective area Δ_{eff} at 1550 nm and/or cable cutoff wavelength of two or more core elements of the multicore optical fiber to be similar even when the propagation constant β differs for at least two of the core elements. In embodiments, the propagation constant β₁ of a first core element differs from the propagation constant β₂ of a second core element and a difference Δ_{eff,1}−Δ_{eff,2} between the effective area Δ_{eff,1} at 1550 nm of the first core element and the effective area Δ_{eff,2} at 1550 nm of the second core element is less than 10 μm², or less than 5 μm², or less than 3 μm², or less than 2 μm², or in a range from 1 μm² to 10 μm², or in a range from 1 μm² to 5 μm², or in a range from 1 μm² to 3 μm². In embodiments with three or more core elements, each core element has an effective area Δ_{eff} at 1550 nm. The effective area Δ_{eff} at 1550 nm of the core elements may differ. Among the core elements, the effective area Δ_{eff} at 1550 nm spans a range extending from a minimum effective area Δ_{eff,min} at 1550 nm for one of the core elements to a maximum effective area Δ_{eff,max} at 1550 nm for another of the core elements. In embodiments, the difference between the maximum effective area Δ_{eff,max} at 1550 nm and the minimum effective area Δ_{eff,min} at 1550 nm is less than 10 μm², or less than 5 μm², or less than 3 μm², or less than 2 μm², or in a range from 1 μm² to 10 μm², or in a range from 1 μm² to 5 μm², or in a range from 1 μm² to 3 μm².

Each core element of the heterogeneous multicore optical fiber has a cable cutoff wavelength λ_{CC} less than 1550 nm, or less than 1530 nm, or less than 1500 nm, or less than 1480 nm, or less than 1460 nm, or less than 1440 nm. The cable cutoff wavelength λ_{CC} of the core elements may differ. In embodiments, the propagation constant β₁ of a first core element differs from the propagation constant β₂ of a second core element and a difference the cable cutoff wavelength λ_{CC,1} of the first core element and the cable cutoff wavelength λ_{CC,2} of the second core element is less than 75 nm, or less than 60 nm, or less than 50 nm, or less than 40 nm, or less than 30 nm, or less than 20 nm, or in a range from 10 nm to 75 nm, or in a range from 10 nm to 50 nm, or in a range from 10 nm to 30 nm. Among the core elements of a plurality of core elements, the cable cutoff wavelength λ_{CC} spans a range extending from a minimum cable cutoff wavelength λ_{CC,min} for one of the core elements to a maximum cable cutoff wavelength λ_{CC,max} for another of the core elements. In embodiments, the difference between the maximum cable cutoff wavelength λ_{CC,max} and the minimum cable cutoff wavelength λ_{CC,min} is less than 75 nm, or less than 60 nm, or less than 50 nm, or less than 40 nm, or less than 30 nm, or less than 20 nm, or in a range from 10 nm to 75 nm, or in a range from 10 nm to 50 nm, or in a range from 10 nm to 30 nm.

For efficient transmission of optical signals over long distances, it is preferable for each core element of the multicore optical fiber to have low attenuation. Low attenuation is favored for core elements having core regions doped with an alkali metal. The attenuation at 1550 nm of each core element of the multicore optical fibers described herein is less than 0.175 dB/km, or less than 0.170 dB/km, or less than 0.165 dB/km, or less than 0.160 dB/km, or less than 0.155 dB/km.

A core element spacing A between at least one pair of adjacent core elements in the multicore glass fiber is greater than 30 μm, or greater than 35 μm, or greater than 40 μm, or greater than 45 μm, or less than 55 μm, or less than 50 μm, or in the range from 30 μm-55 μm, or in the range from 35 μm-55 μm, or in the range from 40 μm-55 μm. In some embodiments, a core element spacing A between the centerlines of at least two pairs of adjacent cores in the multicore glass fiber is greater than 30 μm, or greater than 35 μm, or greater than 40 μm, or greater than 45 μm, or less than 55 μm, or less than 50 μm, or in the range from 30 μm-55 μm, or in the range from 35 μm-55 μm, or in the range from 40 μm-55 μm.

An edge spacing of at least one core element of the multicore optical fiber is less than 30.0 μm, or less than 27.5 μm, or less than 25.0 μm, or less than 22.5 μm, or less than 20.0 μm, or in the range from 15.0 μm-30.0 μm, or in the range from 17.5 μm-27.5 μm, or in the range from 20.0 μm-25.0 μm. In some embodiments, an edge spacing of each of at least two core elements of the multicore optical fiber is less than 30.0 μm, or less than 27.5 μm, or less than 25.0 μm, or less than 22.5 μm, or less than 20.0 μm, or in the range from 15.0 μm-30.0 μm, or in the range from 17.5 μm-27.5 μm, or in the range from 20.0 μm-25.0 μm.

In embodiments, the counterpropagating crosstalk at 1550 nm between any two core elements of the multicore optical fiber at a bend radius greater than 1000 mm is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km.

In embodiments, the counterpropagating crosstalk at 1550 nm between any two core elements of the multicore optical fiber at a bend radius greater than 1500 mm is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km.

In embodiments, the counterpropagating crosstalk at 1550 nm between any two core elements of the multicore optical fiber at a bend radius greater than 2000 mm is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km.

In embodiments, the counterpropagating crosstalk at 1550 nm between at least one pair of adjacent cores in the multicore optical fiber at a bend radius greater than 1000 mm is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km. In some embodiments, the counterpropagating crosstalk at 1550 nm between at least two pairs of adjacent core elements in the multicore optical fiber is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km.

In embodiments, the counterpropagating crosstalk at 1550 nm between at least one pair of adjacent cores in the multicore optical fiber at a bend radius greater than 1500 mm is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km. In some embodiments, the counterpropagating crosstalk at 1550 nm between at least two pairs of adjacent core elements in the multicore optical fiber is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km.

In embodiments, the counterpropagating crosstalk at 1550 nm between at least one pair of adjacent cores in the multicore optical fiber at a bend radius greater than 2000 mm is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km. In some embodiments, the counterpropagating crosstalk at 1550 nm between at least two pairs of adjacent core elements in the multicore optical fiber is less than −55 dB/100 km, or less than −60 dB/100 km, or less than −65 dB/100 km, or less than −70 dB/100 km, or less than −75 dB/100 km, or less than −80 dB/100 km, or in the range from −85 dB/100 km to −55 dB/100 km, or in the range from −80 dB/100 km to −60 dB/100 km, or in the range from −75 dB/100 km to −65 dB/100 km.

For the present heterogeneous multicore optical fibers, the critical bend radius for counterpropagating crosstalk at 1550 nm is less than 2000 mm, or less than 1500 mm, or less than 1000 mm, or less than 500 mm, or less than 300 mm.

In one embodiment, a coating is applied to the outer surface of a common outer cladding region. The coatings are formed from curable coating compositions. Curable coating compositions include one or more curable components. As used herein, the term “curable” is intended to mean that the component, when exposed to a suitable source of curing energy, includes one or more curable functional groups capable of forming covalent bonds that participate in linking the component to itself or to other components of the coating composition. The product obtained by curing a curable coating composition is referred to herein as the cured product of the composition or as a coating. The cured product is preferably a polymer. The curing process is induced by energy. Forms of energy include electromagnetic radiation or thermal energy.

A curable component includes one or more curable functional groups. A curable component with only one curable functional group is referred to herein as a monofunctional curable component. A curable component having two or more curable functional groups is referred to herein as a multifunctional curable component. Multifunctional curable components can introduce crosslinks into the polymeric network that forms during the curing process.

Multifunctional curable components may also be referred to herein as “crosslinkers” or “curable crosslinkers”. Curable components include curable monomers and curable oligomers. Examples of functional groups that participate in covalent bond formation during the curing process are acrylate groups and methacrylate groups.

The coating preferably includes a primary coating surrounding and directly adjacent to a common cladding region and a secondary coating surrounding and directly adjacent to the primary coating. The secondary coating is a harder material (higher Young's modulus) than the primary coating and is designed to protect the multicore glass fiber from damage caused by abrasion or external forces that arise during processing, handling, and installation of the multicore optical fiber. The primary coating is a softer material (lower Young's modulus) than the secondary coating and is designed to buffer or dissipates stresses that result from forces applied to the outer surface of the secondary coating. Dissipation of stresses within the primary coating attenuates the stress and minimizes the stress that reaches the multicore glass fiber. The multicore optical fiber may also include a tertiary coating that surrounds and is directly adjacent to the secondary coating. The tertiary coating may include pigments, inks or other coloring agents to mark the optical fiber for identification purposes and typically has a Young's modulus similar to the Young's modulus of the secondary coating.

Primary and secondary coatings are typically formed on the draw by applying a curable coating composition to the multicore glass fiber as a viscous liquid and curing. In a continuous optical fiber manufacturing process, a glass fiber is drawn from a heated preform and sized to a target diameter. The glass fiber is then cooled and directed to a coating system that applies a liquid primary coating composition to the glass fiber. Two process options are viable after application of the liquid primary coating composition to the glass fiber. In one process option (wet-on-dry process), the liquid primary coating composition is cured to form a solidified primary coating, the liquid secondary coating composition is applied to the cured primary coating, and the liquid secondary coating composition is cured to form a solidified secondary coating. In a second process option (wet-on-wet process), the liquid secondary coating composition is applied to the liquid primary coating composition, and both liquid coating compositions are cured simultaneously to provide solidified primary and secondary coatings. After the fiber exits the coating system, the fiber is collected and stored at room temperature. Collection of the fiber typically entails winding the fiber on a spool and storing the spool.

The primary coating is a cured product of a radiation-curable primary coating composition that includes an oligomer, a monomer, a photoinitiator and, optionally, an additive.

The oligomer preferably includes a polyether urethane diacrylate compound and a di-adduct compound. In one embodiment, the polyether urethane diacrylate compound has a linear molecular structure. In one embodiment, the oligomer is formed from a reaction between a diisocyanate compound, a polyol compound, and a hydroxy acrylate compound, where the reaction produces a polyether urethane diacrylate compound as a primary product (majority product) and a di-adduct compound as a byproduct (minority product). The reaction forms a urethane linkage upon reaction of an isocyanate group of the diisocyanate compound and an alcohol group of the polyol. The hydroxy acrylate compound reacts to quench residual isocyanate groups that are present in the composition formed from reaction of the diisocyanate compound and polyol compound. As used herein, the term “quench” refers to conversion of isocyanate groups through a chemical reaction with hydroxyl groups of the hydroxy acrylate compound. Quenching of residual isocyanate groups with a hydroxy acrylate compound converts terminal isocyanate groups to terminal acrylate groups. The di-adduct compound is a diacrylate compound formed by reaction of both isocyanate groups of the diisocyanate compound with the hydroxy acrylate compound.

The one or more monomers is/are selected to be compatible with the oligomer, to control the viscosity of the primary coating composition to facilitate processing, and/or to influence the physical or chemical properties of the coating formed as the cured product of the primary coating composition. The monomers include radiation-curable monomers such as ethylenically-unsaturated compounds, ethoxylated acrylates, ethoxylated alkylphenol monoacrylates, propylene oxide acrylates, n-propylene oxide acrylates, isopropylene oxide acrylates, monofunctional acrylates, monofunctional aliphatic epoxy acrylates, multifunctional acrylates, multifunctional aliphatic epoxy acrylates, and combinations thereof.

The curable primary coating composition optionally includes one or more additives. Additives include an adhesion promoter, a strength additive, an antioxidant, a catalyst, a stabilizer, an optical brightener, a property-enhancing additive, an amine synergist, a wax, a lubricant, and/or a slip agent.

The secondary coating is a cured product of a curable secondary coating composition that includes a monomer, a photoinitiator, an optional oligomer, and an optional additive.

The monomers preferably include ethylenically unsaturated compounds. The one or more monomers may be present in an amount of 50 wt % or greater, or in an amount from about 60 wt % to about 99 wt %, or in an amount from about 75 wt % to about 99 wt %, or in an amount from about 80 wt % to about 99 wt % or in an amount from about 85 wt % to about 99 wt %. In one embodiment, the secondary coating is the radiation-cured product of a secondary coating composition that contains urethane acrylate monomers.

Representative radiation-curable ethylenically unsaturated monomers for the curable secondary composition include alkoxylated monomers with one or more acrylate or methacrylate groups. An alkoxylated monomer is one that includes one or more alkoxylene groups, where an alkoxylene group has the form —O—R— and R is a linear or branched hydrocarbon. Examples of alkoxylene groups include ethoxylene (—O—CH₂—CH₂—), n-propoxylene (—O—CH₂—CH₂—CH₂—), isopropoxylene (—O—CH₂—CH(CH₃)—), etc.

Representative multifunctional ethylenically unsaturated monomers for the curable secondary coating composition include, without limitation, alkoxylated bisphenol A diacrylates; methylolpropane polyacrylates with and without alkoxylation; ditrimethylolpropane tetraacrylate; alkoxylated glyceryl triacrylates; erythritol polyacrylates with and without alkoxylation; isocyanurate polyacrylates; alcohol polyacrylates with and without alkoxylation; epoxy acrylates; and single and multi-ring cyclic aromatic or non-aromatic polyacrylates.

The optional oligomer present in the radiation-curable secondary coating composition is preferably a compound with urethane linkages.

The curable secondary coating composition also includes a photoinitiator and optionally includes additives such as an antioxidant, an optical brightener, an amine synergist, a tackifier, a catalyst, a carrier or surfactant, and a stabilizer as described above in connection with the curable primary coating composition.

Fiber Draw Process. In a continuous optical fiber manufacturing process, a glass fiber is drawn from a heated preform and sized to a target diameter (typically 125 μm). The glass fiber is then cooled at a controlled rate and directed to a coating system that applies a liquid primary coating composition to the glass fiber. Two process options are viable after application of the liquid primary coating composition to the glass fiber. In one process option (wet-on-dry process), the liquid primary coating composition is cured to form a solidified primary coating, the liquid secondary coating composition is applied to the cured primary coating, and the liquid secondary coating composition is cured to form a solidified secondary coating. In a second process option (wet-on-wet process), the liquid secondary coating composition is applied to the liquid primary coating composition, and both liquid coating compositions are cured simultaneously to provide solidified primary and secondary coatings. After the fiber exits the coating system, the fiber is collected and stored at room temperature. Collection of the fiber typically entails winding the fiber on a spool and storing the spool. Fluid bearing devices may be used to turn and redirect the optical fiber during the draw process.

In some processes, the coating system further applies a tertiary coating composition to the secondary coating and cures the tertiary coating composition to form a solidified tertiary coating. Typically, the tertiary coating is an ink layer used to mark the fiber for identification purposes and has a composition that includes a pigment and is otherwise similar to the secondary coating. The tertiary coating is applied to the secondary coating and cured. The secondary coating has typically been cured at the time of application of the tertiary coating. The primary, secondary, and tertiary coating compositions can be applied and cured in a common continuous manufacturing process. Alternatively, the primary and secondary coating compositions are applied and cured in a common continuous manufacturing process, the coated fiber is collected, and the tertiary coating composition is applied and cured in a separate offline process to form the tertiary coating. The wavelength of curing radiation is infrared, visible, or ultraviolet (UV).

### Aspect 1 of the Description is:

A heterogeneous multicore optical fiber comprising:
   a plurality of core elements, each of the core elements having a core region doped with an alkali metal, the plurality including a first core element and a second core element, the first core element and the second core element differing in relative refractive index profile; and
   a common cladding surrounding and directly contacting each of the core elements of the plurality;
wherein
   the core element spacing Λ between each pair of core elements is greater than or equal to 35 μm;
   each of the core elements has an effective area Δ_{eff} at 1550 nm between 80 μm² and 150 μm², the effective areas Δ_{eff} at 1550 nm of the plurality of core elements spanning a range from a minimum effective area Δ_{eff,min} at 1550 nm to a maximum effective area Δ_{eff,max} at 1550 nm, the maximum effective area Δ_{eff,max} at 1550 nm and the minimum effective area Δ_{eff,min} at 1550 nm differing by less than 5 μm²;
   each of the core elements has a cable cutoff wavelength λ_{CC} less than 1530 nm, the cable cutoff wavelengths λ_{CC} of the plurality of core elements spanning a range from a minimum cable cutoff wavelength λ_{CC,min} to a maximum cable cutoff wavelength λ_{CC,max}, the maximum cable cutoff wavelength λ_{CC,max} and the minimum cable cutoff wavelength λ_{CC},min differing by less than 50 nm; and
   the critical bend radius R_{crit} of the heterogeneous multicore optical fiber at 1550 nm is less than 1500 mm.

### Aspect 2 of the Description is:

The heterogeneous multicore optical fiber according to Aspect 1, wherein the first core element has a first core element radius r_{CE,1} and the second core element has a second core element radius r_{CE,2} and wherein the difference between the first core element radius r_{CE,1} and the second core element radius r_{CE,2} is greater than 1.0 μm.

### Aspect 3 of the Description is:

The heterogeneous multicore optical fiber according to Aspect 2, wherein the difference between the first core element radius r_{CE,1} and the second core element radius r_{CE,2} is greater than 1.5 μm.

### Aspect 4 of the Description is:

The heterogeneous multicore optical fiber according to any of Aspects 1-3, wherein the first core element includes a first core region having a relative refractive index Δ_{1,1} and the second core element includes a second core region having a relative refractive index Δ_{1,2}, the relative refractive index Δ_{1,1} differing from the relative refractive index Δ_{1,2}.

### Aspect 5 of the Description is:

The heterogeneous multicore optical fiber according to Aspect 4, wherein the relative refractive index Δ_{1,1} and the relative refractive index Δ_{1,2} are in the range from −0.10% to 0.10%.

### Aspect 6 of the Description is:

The heterogeneous multicore optical fiber according to Aspect 4, wherein the relative refractive index Δ_{1,1} and the relative refractive index Δ_{1,2} are in the range from −0.05% to 0.05%.

### Aspect 7 of the Description is:

The heterogeneous multicore optical fiber according to any of Aspects 4-6, wherein the difference between the relative refractive index Δ_{1,1} and the relative refractive index Δ_{1,2} is greater than 0.005%.

### Aspect 8 of the Description is:

The heterogeneous multicore optical fiber according to any of Aspects 4-6, wherein the difference between the relative refractive index Δ_{1,1} and the relative refractive index Δ_{1,2} is greater than 0.010%.

### Aspect 9 of the Description is:

The heterogeneous multicore optical fiber according to any of Aspects 1-8, wherein the first core element includes a first core region having a radius r_{1,1} and the second core element includes a second core region having a radius r_{1,2}, the radius r_{1,1} differing from the radius r_{1,2}.

### Aspect 10 of the Description is:

The heterogeneous multicore optical fiber according to Aspect 9, wherein the radius r_{1,1} and the radius r_{1,2} are in the range from 3.0 μm-7.5 μm.

### Aspect 11 of the Description is:

The heterogeneous multicore optical fiber according to Aspect 9 or 10, wherein the difference between the radius r_{1,1} and the radius r_{1,2} is greater than 0.05 μm.

### Aspect 12 of the Description is:

The heterogeneous multicore optical fiber according to Aspect 9 or 10, wherein the difference between the radius r_{1,1} and the radius r_{1,2} is greater than 0.10 μm.

### Aspect 13 of the Description is:

The heterogeneous multicore optical fiber according to any of Aspects 1-12, wherein the first core element includes a first core region and the second core element includes a second core region, the first core region and the second core region having step index relative refractive index profiles.

### Aspect 14 of the Description is:

The heterogeneous multicore optical fiber according to any of Aspects 1-13, wherein the first core element includes a first core region surrounded by and directly adjacent to a first dedicated depressed index cladding region and the second core element includes a second core region surrounded by and directly adjacent to a second dedicated depressed index cladding region, first core region having a relative refractive index Δ_{1,1} in the range from −0.10% to 0.10%, the second core region having a relative refractive index Δ_{1,2} in the range from −0.10% to 0.10%, the first dedicated depressed index cladding region having a relative refractive index Δ_{3,1} in the range from −0.45% to −0.25%, the second dedicated depressed index cladding region having a relative refractive index Δ_{3,2} in the range from −0.45% to −0.25%.

### Aspect 15 of the Description is:

The heterogeneous multicore optical fiber according to Aspect 14, wherein the relative refractive index Δ_{3,1} differs from the relative refractive index Δ_{3,2.}

### Aspect 16 of the Description is:

The heterogeneous multicore optical fiber according to Aspect 15, wherein difference between the relative refractive index Δ_{3,1} and the relative refractive index Δ_{3,2} is greater than 0.005%.

### Aspect 17 of the Description is:

The heterogeneous multicore optical fiber according to Aspect 15, wherein difference between the relative refractive index Δ_{3,1} and the relative refractive index Δ_{3,2} is greater than 0.01%.

### Aspect 18 of the Description is:

The heterogeneous multicore optical fiber according to any of Aspects 14-17, wherein the relative refractive index Δ_{3,1} in the range from −0.40% to −0.30%.

### Aspect 19 of the Description is:

The heterogeneous multicore optical fiber according to any of Aspects 14-18, wherein the first dedicated depressed index cladding region has a radius r_{3,1} in the range from 12.5 μm-22.5 μm and the second dedicated depressed index cladding region has a radius r_{3,2} in the range from 12.5 μm-22.5 μm.

### Aspect 20 of the Description is:

The heterogeneous multicore optical fiber according to Aspect 19, wherein the radius r_{3,1} differs from the radius r_{3,2.}

### Aspect 21 of the Description is:

The heterogeneous multicore optical fiber according to Aspect 20, wherein the difference between the radius r_{3,1} and the radius r_{3,2} is greater than 0.50 μm.

### Aspect 22 of the Description is:

The heterogeneous multicore optical fiber according to Aspect 20, wherein the difference between the radius r_{3,1} and the radius r_{3,2} is greater than 1.50 μm.

### Aspect 23 of the Description is:

The heterogeneous multicore optical fiber according to any of Aspects 19-22, wherein the radius r_{3,1} in the range from 15.0 μm-20.0 μm and the radius r_{3,2} in the range from 15.0 μm-20.0 μm.

### Aspect 24 of the Description is:

The heterogeneous multicore optical fiber according to any of Aspects 14-23, wherein the first core region has a radius r_{1,1} and the second core region has a radius r_{1,2}, the first dedicated depressed index cladding region has a radius r_{3,1} and a thickness r_{3,1}−r_{1,1}, the second dedicated depressed index cladding region has a radius r_{3,2} and a thickness r_{3,2}−r_{1,2}, the thickness r_{3,1}−r_{1,1} differing from the thickness r_{3,2}−r_{1,2}.

### Aspect 25 of the Description is:

The heterogeneous multicore optical fiber according to Aspect 24, wherein the difference between the thickness r_{3,1}−r_{1,1} and the thickness r_{3,2}−r_{1,2} is greater than 0.50 μm.

### Aspect 26 of the Description is:

The heterogeneous multicore optical fiber according to Aspect 24, wherein the difference between the thickness r_{3,1}−r_{1,1} and the thickness r_{3,2}−r_{1,2} is greater than 1.50 μm.

### Aspect 27 of the Description is:

The heterogeneous multicore optical fiber according to any of Aspects 14-26, wherein the common cladding region surrounds and directly contacts the first dedicated depressed index cladding region and the second dedicated depressed index cladding region.

### Aspect 28 of the Description is:

The heterogeneous multicore optical fiber according to Aspect 14, wherein the first core element further includes a first dedicated outer cladding region surrounding and directly adjacent to the first dedicated depressed index cladding region, the first dedicated outer cladding region having a relative refractive index Δ_{4doc} in the range from −0.40% to −0.25%.

### Aspect 29 of the Description is:

The heterogeneous multicore optical fiber according to Aspect 28, wherein the first dedicated outer cladding region has a radius r₄ in the range from 15.0 μm to 30.0 μm.

### Aspect 30 of the Description is:

The heterogeneous multicore optical fiber according to Aspect 28 or 29, wherein the common cladding region surrounds and is directly adjacent to the first dedicated outer cladding region and the second dedicated depressed index cladding region.

### Aspect 31 of the Description is:

The heterogeneous multicore optical fiber according to any of Aspects 1-30, wherein the common cladding region has a relative refractive index Δ₄ in the range from −0.35% to −0.10%.

### Aspect 32 of the Description is:

The heterogeneous multicore fiber according to any of Aspects 1-31, wherein the radius R₄ of the common cladding is between 120 μm and 130 μm.

### Aspect 33 of the Description is:

The heterogeneous multicore optical fiber according to any of Aspects 1-32, wherein the first core element and the second core element differ in the number of dedicated cladding regions.

### Aspect 34 of the Description is:

The heterogeneous multicore optical fiber according to any of Aspects 1-33, wherein the multicore optical fiber is free of any marker element.

### Aspect 35 of the Description is:

The heterogeneous multicore fiber according to any of Aspects 1-34, wherein the effective area Δ_{eff} at 1550 nm of each of the core elements is between 100 μm² and 135 μm².

### Aspect 36 of the Description is:

The heterogeneous multicore fiber according to any of Aspects 1-35, wherein the core element spacing Λ between each pair of the core elements is greater than or equal to 40 μm.

### Aspect 37 of the Description is:

The heterogeneous multicore fiber according to any of Aspects 1-35, wherein the core element spacing Λ between each pair of the core elements is greater than or equal to 45 μm.

### Aspect 38 of the Description is:

The heterogeneous multicore fiber according to any of Aspects 1-37, wherein the attenuation of each of the core elements at 1550 nm is less than 0.165 dB/km.

### Aspect 39 of the Description is:

The heterogeneous multicore fiber according to any of Aspects 1-37, wherein the attenuation of each of the core elements at 1550 nm is less than 0.160 dB/km.

### Aspect 40 of the Description is:

The heterogeneous multicore fiber according to any of Aspects 1-37, wherein the attenuation of each of the core elements at 1550 nm is less than 0.155 dB/km.

### Aspect 41 of the Description is:

The heterogeneous multicore fiber according to any of Aspects 1-40, wherein the critical bend radius R_{crit} is less than 1000 mm.

### Aspect 42 of the Description is:

The heterogeneous multicore fiber according to any of Aspects 1-40, wherein the critical bend radius R_{crit} is less than 600 mm.

### Aspect 43 of the Description is:

The heterogeneous multicore fiber according to any of Aspects 1-42, wherein the maximum cable cutoff wavelength λ_{CC,max} and the minimum cable cutoff wavelength λ_{CC,min} among the core elements differ by less than 30 nm.

### Aspect 44 of the Description is:

The heterogeneous multicore fiber according to any of Aspects 1-43, wherein the maximum effective area Δ_{eff,max} at 1550 nm and the minimum effective area Δ_{eff,min} at 1550 nm among the core elements differ by less than 3 μm².

### Aspect 45 of the Description is:

The heterogeneous multicore fiber according to any of Aspects 1-44, wherein the number of the core elements in the plurality is greater than or equal to 3.

### Aspect 46 of the Description is:

The heterogeneous multicore fiber according to any of Aspects 1-44, wherein the number of the core elements in the plurality is greater than or equal to 4.

### Aspect 47 of the Description is:

The heterogeneous multicore optical fiber according to any of Aspects 1-46, wherein the heterogeneous multicore optical fiber has a counterpropagating crosstalk at 1550 nm less than −45 dB/100 km.

### Aspect 48 of the Description is:

The heterogeneous multicore optical fiber according to Aspect 47, wherein the heterogeneous multicore optical fiber is bent with a bending radius greater than 500 mm.

### Aspect 49 of the Description is:

The heterogeneous multicore optical fiber according to Aspect 47, wherein the heterogeneous multicore optical fiber is bent with a bending radius greater than 800 mm.

### Aspect 50 of the Description is:

The heterogeneous multicore optical fiber according to Aspect 47, wherein the heterogeneous multicore optical fiber is bent with a bending radius greater than 1200 mm.

### Aspect 51 of the Description is:

The heterogeneous multicore optical fiber according to any of Aspects 47-50, wherein the counterpropagating crosstalk at 1550 nm is less than −55 dB/100 km.

### Aspect 52 of the Description is:

A cable comprising the heterogeneous multicore optical fiber according to any of Aspects 1-51.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A heterogeneous multicore optical fiber comprising:
a plurality of core elements, each of the core elements having a core region doped with an alkali metal, the plurality including a first core element and a second core element, the first core element and the second core element differing in relative refractive index profile; and
a common cladding surrounding and directly contacting each of the core elements of the plurality;
wherein
the core element spacing Λ between each pair of core elements is greater than or equal to 35 μm;
each of the core elements has an effective area Δ_{eff} at 1550 nm between 80 μm² and 150 μm², the effective areas Δ_{eff} at 1550 nm of the plurality of core elements spanning a range from a minimum effective area Δ_{eff,min} at 1550 nm to a maximum effective area Δ_{eff,max} at 1550 nm, the maximum effective area Δ_{eff,max} at 1550 nm and the minimum effective area Δ_{eff,min} at 1550 nm differing by less than 5 μm²;
each of the core elements has a cable cutoff wavelength λ_{CC} less than 1530 nm, the cable cutoff wavelengths λ_{CC} of the plurality of core elements spanning a range from a minimum cable cutoff wavelength λ_{CC,min} to a maximum cable cutoff wavelength λ_{CC,max}, the maximum cable cutoff wavelength λ_{CC,max} and the minimum cable cutoff wavelength λ_{CC,min} differing by less than 50 nm; and
the critical bend radius R_{crit} of the heterogeneous multicore optical fiber at 1550 nm is less than 1500 mm.

2. The heterogeneous multicore optical fiber of claim 1, wherein the first core element has a first core element radius r_{CE,1} and the second core element has a second core element radius r_{CE,2} and wherein the difference between the first core element radius r_{CE,1} and the second core element radius r_{CE,2} is greater than 1.0 μm.

3. The heterogeneous multicore optical fiber of claim 1, wherein the first core element includes a first core region having a relative refractive index Δ_{1,1} and the second core element includes a second core region having a relative refractive index Δ_{1,2}, the relative refractive index Δ_{1,1} differing from the relative refractive index Δ_{1,2}.

4. The heterogeneous multicore optical fiber of claim 3, wherein the relative refractive index Δ_{1,1} and the relative refractive index Δ_{1,2} are in the range from −0.10% to 0.10%.

5. The heterogeneous multicore optical fiber of claim 3, wherein the difference between the relative refractive index Δ_{1,1} and the relative refractive index Δ_{1,2} is greater than 0.010%.

6. The heterogeneous multicore optical fiber of claim 1, wherein the first core element includes a first core region having a radius r_{1,1} and the second core element includes a second core region having a radius r_{1,2}, the radius r_{1,1} differing from the radius r_{1,2.}

7. The heterogeneous multicore optical fiber of claim 6, wherein the radius r_{1,1} and the radius r_{1,2} are in the range from 3.0 μm-7.5 μm.

8. The heterogeneous multicore optical fiber of claim 6, wherein the difference between the radius r_{1,1} and the radius r_{1,2} is greater than 0.10 μm.

9. The heterogeneous multicore optical fiber of claim 1, wherein the first core element includes a first core region surrounded by and directly adjacent to a first dedicated depressed index cladding region and the second core element includes a second core region surrounded by and directly adjacent to a second dedicated depressed index cladding region, first core region having a relative refractive index Δ_{1,1} in the range from −0.10% to 0.10%, the second core region having a relative refractive index Δ_{1,2} in the range from −0.10% to 0.10%, the first dedicated depressed index cladding region having a relative refractive index Δ_{3,1} in the range from −0.45% to −0.25%, the second dedicated depressed index cladding region having a relative refractive index Δ_{3,2} in the range from −0.45% to −0.25%.

10. The heterogeneous multicore optical fiber of claim 9, wherein the relative refractive index Δ_{3,1} differs from the relative refractive index Δ_{3,2.}

11. The heterogeneous multicore optical fiber of claim 9, wherein the first dedicated depressed index cladding region has a radius r_{3,1} in the range from 12.5 μm-22.5 μm and the second dedicated depressed index cladding region has a radius r_{3,2} in the range from 12.5 μm-22.5 μm.

12. The heterogeneous multicore optical fiber of claim 11, wherein the radius r_{3,1} differs from the radius r_{3,2}.

13. The heterogeneous multicore optical fiber of claim 9, wherein the first core region has a radius r_{1,1} and the second core region has a radius r_{1,2}, the first dedicated depressed index cladding region has a radius r_{3,1} and a thickness r_{3,1}−r_{1,1}, the second dedicated depressed index cladding region has a radius r_{3,2} and a thickness r_{3,2}−r_{1,2}, the thickness r_{3,1}−r_{1,1} differing from the thickness r_{3,2}−r_{1,2}.

14. The heterogeneous multicore optical fiber of claim 9, wherein the common cladding region surrounds and directly contacts the first dedicated depressed index cladding region and the second dedicated depressed index cladding region.

15. The heterogeneous multicore optical fiber of claim 9, wherein the first core element further includes a first dedicated outer cladding region surrounding and directly adjacent to the first dedicated depressed index cladding region, the first dedicated outer cladding region having a relative refractive index Δ_{4doc} in the range from −0.40% to −0.25%.

16. The heterogeneous multicore optical fiber of claim 1, wherein the common cladding region has a relative refractive index Δ₄ in the range from −0.35% to −0.10%.

17. The heterogeneous multicore optical fiber of claim 1, wherein the first core element and the second core element differ in the number of dedicated cladding regions.

18. The heterogeneous multicore fiber of claim 1, wherein the effective area Δ_{eff} at 1550 nm of each of the core elements is between 100 μm² and 135 μm².

19. The heterogeneous multicore fiber of claim 1, wherein the core element spacing Λ between each pair of the core elements is greater than or equal to 40 μm.

20. The heterogeneous multicore fiber of claim 1, wherein the critical bend radius R_{crit} is less than 1000 mm.

21. The heterogeneous multicore optical fiber of claim 1, wherein the heterogeneous multicore optical fiber has a counterpropagating crosstalk at 1550 nm less than −45 dB/100 km.

22. The heterogeneous multicore optical fiber of claim 21, wherein the heterogeneous multicore optical fiber is bent with a bending radius greater than 500 mm.
